(19) United States
(12) Patent Application Publication
(10) Pub. No.: US 2025/0163296 A1
(43) Pub. Date: May 22, 2025

(54) POLYESTERAMIDE COMPOSITIONS FOR METAL PACKAGING COATINGS

(71) Applicant: Eastman Chemical Company, Kingsport, TN (US)

(72) Inventors: Hongkun He, Kingsport, TN (US); Selene Ayde De Leon Ibarra, Kingsport, TN (US); Linqian Feng, Piney Flats, TN (US); Goliath Beniah, Johnson City, TN (US); Thauming Kuo, Kingsport, TN (US)

(73) Assignee: Eastman Chemical Company, Kingsport, TN (US)

(21) Appl. No.: 18/832,994

(22) PCT Filed: Jan. 25, 2023
(86) PCT No.: PCT/US2023/061212

§ 371 Date: Jul. 25, 2024

Related U.S. Application Data
(60) Provisional application No. 63/267,351, filed on Jan. 31, 2022.

(51) Int. Cl. C09D 177/12; C08G 69/44; C08K 5/29

(52) U.S. Cl. CPC C09D 177/12; C08G 69/44; C08K 5/29; C08G 2150/00

(57) ABSTRACT

This invention relates to polyesteramide compositions that are curable with isocyanates, phenolic resins, amino resins, or a combination thereof. The polyesteramide compositions comprise a cycloaliphatic diol such as 2,2,4,4-tetramethyl-1,3-cyclobutanediol (TMCD). Coating compositions prepared from such polyesteramides are capable of providing a good balance of the desirable coating properties such as solvent resistance and wedge bend resistance for metal packaging applications.

### FIELD OF THE INVENTION

This application relates to polyesteramide compositions. In particular, this invention relates to polyesteramide compositions that are curable with isocyanates, phenolic resins, amino resins, or a combination thereof. More particularly, this invention relates to polyesteramide compositions comprising a cycloaliphatic diol such as 2,2,4,4-tetramethyl-1,3-cyclobutanediol (TMCD). Coating compositions prepared from such polyesteramides are capable of providing a good balance of desirable coating properties such as solvent resistance and wedge bend resistance for metal packaging applications.

### BACKGROUND OF THE INVENTION

Metal containers are commonly used for food and beverage packaging. The containers are typically made of steel or aluminum. A prolonged contact between the metal and the filled product can lead to corrosion of the container. To prevent direct contact between filled product and metal, a coating is typically applied to the interior of the food and beverage cans. In order to be effective, such a coating must have adequate properties that are needed for protecting the packaged products, such as adhesion, corrosion resistance, chemical resistance, flexibility, stain resistance, and hydrolytic stability. Moreover, the coating must be able to withstand processing conditions during can fabrication and food sterilization. Coatings based on a combination of epoxy and phenolic resins are known to be able to provide a good balance of the required properties and are most widely used. There are industry sectors moving away from food contact polymers made with bisphenol A (BPA), a basic building block of epoxy resins. Thus, there exists a desire for the replacement of epoxy resin used in interior can coatings.

Polyester resins are of particular interest to the coating industry to be used as a replacement for epoxy resin because of their comparable properties such as flexibility and adhesion. 2,2,4,4-Tetramethyl-1,3-cyclobutanediol (TMCD) is a cycloaliphatic compound that can be used as a diol component for making polyesters. Thermoplastics based on TMCD polyester exhibit improved impact resistance owing to TMCD's unique structure. TMCD can also provide improved hydrolytic stability of the polyester due to its secondary hydroxyl functionality. Both of these properties are highly desirable in thermosetting coatings.

Polyesters based on TMCD exhibit higher glass transition temperatures, which is desirable for coatings capable of withstanding processing conditions during can fabrication. High Tg polyesters are also desirable for food sterilization at high temperatures. Coatings based on such polyesters, however, tend to be less flexible, which can have detrimental effects on microcracking (crazing) resistance and bending ability during processing. Thus, there remains a need for a suitable polyester composition that can provide a good balance of the desirable coating properties for metal packaging applications.

### SUMMARY OF THE INVENTION

In one embodiment of the invention, there is provided a coating composition for metal packaging application, which comprises:
a. a polyesteramide, which is the reaction product of the monomers comprising:
   i. 2,2,4,4-tetramethyl-1,3-cyclobutanediol (TMCD) in an amount of 25-80 mole %, based on the total moles of i-iv,
   ii. a diol other than TMCD in an amount of 15-73 mole %, based on the total moles of i-iv,
   iii. an aliphatic diamine in an amount of 0.2-20 mole %, based on the total moles of i-iv,
   iv. a polyol in an amount of 0-20 mole %, based on the total moles of i-iv,
   v. an aromatic diacid in an amount of 60-100 mole %, based on the total moles of v-vi, and
   vi. an aliphatic diacid in an amount of 0-40 mole %, based on the total moles of v-vi, and
b. one or more crosslinkers selected from the group consisting of resole phenolic resin, isocyanate, and amino resin crosslinkers,
wherein said polyesteramide has a glass transition temperature (Tg) of 60-100° C., acid number of 0-10 mgKOH/g, hydroxyl number of 5-60 mgKOH/g, number average molecular weight of 3000-25000 g/mole, and weight average molecular weight of 10000-150000 g/mole.

In a further embodiment, this invention provides a coating composition for metal packaging application, which comprises:
a. a linear polyesteramide in an amount of 65-85 weight %, based on the total weight of (a), (b), and (c), which is the reaction product of the monomers comprising:
   i. 2,2,4,4-tetramethyl-1,3-cyclobutanediol (TMCD) in an amount of 35-45 mole %, based on the total moles of i-iv,
   ii. 1,4-cyclohexanedimethanol in an amount of 20-45 mole %, based on the total moles of i-iv,
   iii. 2-methyl-1,3-propanediol in an amount of 10-30 mole %, based on the total moles of i-iv,
   iv. an aliphatic diamine in an amount of 0.2-10 mole %, based on the total moles of i-iv,
   v. isophthalic acid in an amount of 60-80 mole %, based on the total moles of v-vii,
   vi. terephthalic acid in an amount of 20-40 mole %, based on the total moles of v-vii, and
   vii. an aliphatic diacid in an amount of 0-10 mole %, based on the total moles of v-vii, and
b. a resole phenolic resin in an amount of 8-30 weight % based on the total weight of (a), (b), and (c), and
c. isophorone diisocyanate (IPDI) in an amount of 3-15 weight % based on the total weight of (a), (b), and (c),
   wherein the linear polyesteramide has a glass transition temperature (Tg) of 70 to 90° C., acid number of 0 to 10 mgKOH/g, hydroxyl number of 5 to 15 mgKOH/g, number average molecular weight of 8,000 to 20,000 mgKOH/g, and weight average molecular weight of 20,000 to 100,000; and wherein said coating has MEK double rubs of 50 to 100 or greater as measured by the method of ASTM D7835 and a wedge bend resistance (% pass) of 70-100 as measured by the method of ASTM D3281.

In another embodiment, this invention provides a coating composition for metal packaging application, which comprises:
a. a linear polyesteramide in an amount of 70-90 weight %, based on the total weight of (a) and (b), which is the reaction product of the monomers comprising:
   i. 2,2,4,4-tetramethyl-1,3-cyclobutanediol (TMCD) in an amount of 35-45 mole %, based on the total moles of i-iv,
   ii. 1,4-cyclohexanedimethanol in an amount of 20-45 mole %, based on the total moles of i-iv,
   iii. 2-methyl-1,3-propanediol in an amount of 10-30 mole %, based on the total moles of i-iv,
   iv. an aliphatic diamine in an amount of 0.2-10 mole %, based on the total moles of i-iv,
   v. isophthalic acid in an amount of 60-80 mole %, based on the total moles of v-vii,
   vi. terephthalic acid in an amount of 20-40 mole %, based on the total moles of v-vii, and
   vii. an aliphatic diacid in an amount of 0-10 mole %, based on the total moles of v-vii, and
b. isophorone diisocyanate (IPDI) in an amount of 10-30 weight % based on the total weight of (a) and (b),
   wherein the linear polyesteramide has a glass transition temperature (Tg) of 70 to 90° C., acid number of 0 to 10 mgKOH/g, hydroxyl number of 5 to 15 mgKOH/g, number average molecular weight of 8,000 to 20,000 mgKOH/g, and weight average molecular weight of 20,000 to 100,000; and wherein said coating has MEK double rubs of 50 to 100 or greater as measured by the method of ASTM D7835 and a wedge bend resistance (% pass) of 70-100 as measured by the method of ASTM D3281.

### BRIEF DESCRIPTION OF THE DRAWING

FIG. 1 illustrates a modified Metal Bead Roller forming beads on a metal sheet.

### DETAILED DESCRIPTION

In this specification and in the claims that follow, reference will be made to a number of terms, which shall be defined to have the following meanings.

“Alcohol” means a chemical containing one or more hydroxyl groups.

“Aldehyde” means a chemical containing one or more —C(O)H groups.

“Acyclic” means a compound or molecule having no rings of atoms in the compound's structure.

“Aliphatic” means a compound having a non-aromatic structure.

“Diacid” means a compound having two carboxyl functional groups.

“Diamine” means a compound containing to amino groups.

Values may be expressed as “about” or “approximately” a given number. Similarly, ranges may be expressed herein as from “about” one particular value and/or to “about” or another particular value. When such a range is expressed, another aspect includes from the one particular value and/or to the other particular value. Similarly, when values are expressed as approximations, by use of the antecedent “about,” it will be understood that the particular value forms another aspect.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “includes,” and “include” have the same open-ended meaning as “comprising,” “comprises,” and “comprise” provided above.

“Chosen from” as used herein can be used with “or” or “and.” For example, Y is chosen from A, B, and C means Y can be individually A, B, or C. Alternatively, Y is chosen from A, B, or C means Y can be individually A, B, or C; or a combination of A and B, A and C, B and C, or A, B, and C.

As used herein numerical ranges are intended to include the beginning number in the range and the ending number in the range and all numerical values and ranges in between the beginning and ending range numbers. For example, the range 40° C. to 60° C. includes the ranges 40° C. to 59° C., 41° C. to 60° C., 41.5° C. to 55.75° C. and 40°, 41°, 42°, 43°, etc. through 60° C.

Disclosed herein is an unexpected discovery that coating compositions based on polyesteramides comprising 2,2,4,4-tetramethyl-1,3-cyclobutanediol (TMCD) are capable of providing a good balance of the desirable coating properties, such as solvent resistance, acid resistance, retort resistance, microcracking resistance, and bending ability, for metal packaging applications.

In one embodiment of the invention, there is provided a coating composition for metal packaging application, which comprises:
a. a polyesteramide, which is the reaction product of the monomers comprising:
   i. 2,2,4,4-tetramethyl-1,3-cyclobutanediol (TMCD) in an amount of 25-80 mole %, based on the total moles of i-iv,
   ii. a diol other than TMCD in an amount of 15-73 mole %, based on the total moles of i-iv,
   iii. an aliphatic diamine in an amount of 0.2-20 mole %, based on the total moles of i-iv,
   iv. a polyol in an amount of 0-20 mole %, based on the total moles of i-iv,
   v. an aromatic diacid in an amount of 60-100 mole %, based on the total moles of v-vi, and
   vi. an aliphatic diacid in an amount of 0-40 mole %, based on the total moles of v-vi, and
b. one or more crosslinkers selected from the group consisting of resole phenolic resin, isocyanate, and amino resin crosslinkers,
wherein said polyesteramide has a glass transition temperature (Tg) of 60-100° C., acid number of 0-10 mgKOH/g, hydroxyl number of 5-60 mgKOH/g, number average molecular weight of 3000-25000 g/mole, and weight average molecular weight of 10000-150000 g/mole.

In another embodiment, said coating exhibits one or more of the following properties: a solvent resistance of greater than 50 MEK double rubs as measured by ASTM D7835; and a wedge bend resistance (% pass) of 70-100 as measured by the method of ASTM D3281.

In yet another embodiment, said coating has a microcracking resistance rating of 2.5-5 and a total retort resistance rating (%) of 70-100 as measured by the methods specified in the example section.

In still another embodiment, said coating has an Erichsen cup test rating of 2-4 (before retort) as measured by the method specified in the example section.

In some embodiments of the invention, said TMCD (i) is in an amount of 25-80 mole % or 30-60 mole % or 35-45 mole %, based on the total moles of (i)-(iv).

In some embodiments of the invention, said diol other than TMCD (ii) is in an amount of 15-73 mole % or 30-66 mole % or 40-60 mole %, based on the total moles of (i)-(iv).

In some embodiments of the invention, said aliphatic diamine (iii) is in an amount of 0.2-20 mole % or 0.5-20 mole % or 1-20 mole % or 1.5-20 mole % or 2-20 mole % or 1-15 mole % or 2-15 mole % or 1-10 mole %, or 2-10 mole %, based on the total moles of (i)-(iv).

In some embodiments of the invention, said polyol (iv) is in an amount of 0-20 mole %, 0-10 mole %, 0-5 mole %, 0-3 mole %, 0-2 mole % or 0-1 mole %, based on the total moles of (i)-(iv).

In some embodiments of the invention said aromatic diacid (v) is in an amount of 60-100 mole %, 70-100 mole %, 80-100 mole %, or 90-100 mole %, based on the total moles of (v)-(vi).

In some embodiments of the invention said aliphatic diacid (vi) is in an amount of 0-40 mole %, 0-30 mole %, 0-20 mole %, or 0-10 mole %, based on the total moles of (v)-(vi).

In another embodiment, TMCD (i) is in an amount of 30-60 mole % based on the total moles of (i)-(iv), the diol other than TMCD (ii) is in an amount of 30-66 mole % based on the total moles of (i)-(iv), aliphatic diamine (III) is in amount of 2-15 mole % based on the total moles of (i)-(iv), polyol (iv) is in an amount of 0-10 mole % based on the total moles of (i)-(iv); aromatic diacid (v) is in an amount of 80-100 mole % based on the total moles of (v)-(vi), and aliphatic diacid (vi) is in an amount of 0-20 mole %, based on the total amount of (v)-(vi).

In still another embodiment, the a. polyesteramide is a linear polyesteramide in an amount of 65-85 wt. %, based on the total weight of (a) and (b), and: i. TMCD is in an amount of 35-45 mole %, based on the total moles of i-iv; ii. the diol other than TMCD is a mixture of 1,4-cyclohexanedimethanol and 2-methyl-1,3-propanediol, wherein the 1,4-cyclohexanedimethanol is in an amount of 20-45 mole %, based on the total moles of i-iv, and 2-methyl-1,3-propanediol is in an amount of 10-30 mole %, based on the total moles of i-iv; iii. the aliphatic diamine is in an amount of 0.2-10 mole %, based on the total moles of i-iv; iv. the polyol is in an amount of 0-20 mole %, based on the total moles of i-iv; v. the aromatic diacid is a mixture of isophthalic acid and terephthalic acid, wherein the isophthalic acid is in an amount of 60-80 mole %, based on the total moles of v-vi, and the terephthalic acid is in an amount of 20-40 mole %, based on the total moles of v-vi; and vi. the aliphatic diacid is in an amount of 0-10 mole %, based on the total moles of v-vi; and b. the one or more crosslinker is a mixture of resole phenolic resin and an isophorone diisocyanate (IPDI), wherein the resole phenolic resin is in an amount of 8-30 weight % based on the total weight of (a) and (b), and the IPDI is in an amount of 3-15 weight % based on the total weight of (a) and (b); and wherein the linear polyesteramide has a glass transition temperature (Tg) of 70 to 90° C., acid number of 0 to 10 mgKOH/g, hydroxyl number of 5 to 15 mgKOH/g, number average molecular weight of 8,000 to 20,000 mgKOH/g, and weight average molecular weight of 20,000 to 100,000.

In still another embodiment, the a. polyesteramide is a linear polyesteramide in an amount of 70-90 weight %, based on the total weight of (a) and (b), and: i. TMCD is in an amount of 35-45 mole %, based on the total moles of i-iv; ii. the diol other than TMCD is a mixture of 1,4-cyclohexanedimethanol and 2-methyl-1,3-propanediol, wherein the 1,4-cyclohexanedimethanol is in an amount of 20-45 mole %, based on the total moles of i-iv, and 2-methyl-1,3-propanediol is in an amount of 10-30 mole %, based on the total moles of i-iv; iii. the aliphatic diamine is in an amount of 0.2-10 mole %, based on the total moles of i-iv; iv. the polyol is in an amount of 0-20 mole %, based on the total moles of i-iv; v. the aromatic diacid is a mixture of isophthalic acid and terephthalic acid, wherein the isophthalic acid is in an amount of 60-80 mole %, based on the total moles of v-vi, and terephthalic acid is in an amount of 20-40 mole %, based on the total moles of v-vi; and vi. the aliphatic diacid is in an amount of 0-10 mole %, based on the total moles of v-vi; and b. the one or more crosslinker is an isophorone diisocyanate (IPDI) in an amount of 10-30 weight % based on the total weight of (a) and (b); and wherein the linear polyesteramide has a glass transition temperature (Tg) of 70 to 90° C., acid number of 0 to 10 mgKOH/g, hydroxyl number of 5 to 15 mgKOH/g, number average molecular weight of 8,000 to 20,000 mgKOH/g, and weight average molecular weight of 20,000 to 100,000.

In still another embodiment, TMCD (i) is in an amount of 35-45 mole % based on the total moles of (i)-(iv), the diol other than TMCD (ii) is in an amount of 40-60 mole % based on the total moles of (i)-(iv), aliphatic diamine (III) is in amount of 2-10 mole % based on the total moles of (i)-(iv), polyol (iv) is in an amount of 0-5 mole % based on the total moles of (i)-(iv); aromatic diacid (v) is in an amount of 90-100 mole % based on the total moles of (v)-(vi), and aliphatic diacid (vi) is in an amount of 0-10 mole %, based on the total amount of (v)-(vi).

Said diol other than TMCD (ii) includes 1,4-cyclohexanedimethanol (1,4-CHDM), 1,3-cyclohexanedimethanol (1,3-CHDM), 2-methyl-1,3-propanediol (MPdiol), neopentyl glycol (NPG), isosorbide, and mixtures thereof. Desirably, said diol other than TMCD is 1,4-CHDM or MPdiol or a mixture thereof.

Said aliphatic diamine (iii) includes 1,6-hexamethylenediamine (HDA), 2-methyl-1,5-pentanediamine (MPDA), 4,4′-methylenebis(2-methylcyclohexylamine) (MACM), 4,4′-methylenebis(cyclohexylamine) (PACM), 1,3-cyclohexanebis(methylamine), 1,4-cyclohexanebis(methylamine), 4,4′-methylenebis(3-methylcyclohexan-1-amine), 4-((4-aminocyclohexyl)methyl)-2-methylcyclohexan-1-amine, 4,4′-methylenebis(2,6-dimethylcyclohexan-1-amine), 2,4,5-trimethyl-1,6-hexanediamine, 5-amino-1,3,3-trimethylcyclohexanemethylamine, 1,3-pentanediamine, 1,3-Propanediamine 1,4-butanediamine, 1,5-pentanediamine, 1,7-heptanediamine, 1,8-octanediamine, 1,9-nonanediamine, 1,10-decanediamine, 1,11-undecanediamine, 1,12-dodecanediamine, 4,7,10-trioxa-1,13-tridecanediamine, 2,2′-(ethylenedioxy)diethylamine, and 2-(2-aminoethoxy)ethylamine.

Said polyol (iv) includes trimethylolpropane (TMP), trimethanolethane, glycerol, pentaerythritol, and mixtures thereof.

Said aromatic diacid (v) includes isophthalic acid (IPA), terephthalic acid (TPA), their esters, such as dimethyl isophthalate and dimethyl terephthalate, and mixtures thereof.

Said aliphatic diacid (vi) includes C₄-C₁₂ diacids and their esters, such as succinic acid, adipic acid, sebacic acid, dodecanedioic acid, 1,4-cyclohexane dicarboxylic acid, 1,3-cyclohexane dicarboxylic acid, and their methyl esters; and (hydrogenated) dimer acid (C₃₆). Desirably, when longer chain diacids (>C₁₀) are used, they are at a smaller ratio such as 1-10, 1-5, 1-3, or 1-2 mole %. In one aspect, said aliphatic diacid is adipic acid, sebacic acid, cyclohexane dicarboxylic acid, or mixtures thereof at a ratio of 10-30 mole %.

Said polyesteramide has a glass transition temperature (Tg) of 60-100° C., 65-95° C., or 70-90° C.

Said polyesteramide has a number average weight of 3,000-25,000, 6,000-23,000, or 8,000-20,000 g/mole; weight average weight of 10,000-150,000, 15,000-130,000, or 20,000-100,000 g/mole.

Said polyesteramide has an inherent viscosity of 0.05-0.8, 0.1-0.7, 0.2-0.7, 0.3-0.7, 0.4-0.7, 0.5-0.7, 0.6-0.7, 0.1-0.6, 0.2-0.6, 0.3-0.6, 0.4-0.6, 0.5-0.6, 0.1-0.5, 0.2-0.5, 0.3-0.5, 0.4-0.5, 0.1-0.4, 0.2-0.4, 0.3-0.4, 0.1-0.3, or 0.2-0.3 dL/g (determined at 25° C., using 0.5 weight % solution in 60/40 phenol/1, 1,2,2-tetrachloroethane by weight).

Said polyesteramide has an acid number of 0-10, 0-8, 0-5, 0-3, 0-2, or 0-1 mgKOH/g.

Said polyesteramide has a hydroxyl number of 5-60, 5-50, 5-40, 5-30, 5-25, 5-20, 5-15, or 5-10 mgKOH/g.

In another embodiment of the invention, wherein the polyesteramide (a) is the reaction product of an additional monomer comprising an α,β-unsaturated diacid or anhydride selected from the group consisting of maleic anhydride, maleic acid, fumaric acid, itaconic anhydride, itaconic acid, and a mixture thereof. In some embodiments said α,β-unsaturated diacid or anhydride is in an amount of 0-30, 0-20, 0-10, or 0-5 mole %, based on the total moles of the diacid components.

In another embodiment, the coating composition of the present invention comprises said polyesteramide (a) is in an amount of 50-85 weight % and said crosslinker (b) in an amount of 15-50 weight %, based on the total weight of (a) and (b). In some embodiments, the polyesteramide (a) is in 55-80, 60-80, 65-80, 70-80, 70-85, 65-85, 60-85, 60-75, or 65-70 weight %; and the crosslinker (b) in 20-45, 20-40, 35-20, 20-30, 15-30, 15-35, 15-40, 25-40, or 30-35 weight %.

Said crosslinker (b) is one or more selected from the group consisting of resole phenolic resin, isocyanate, and amino resin crosslinkers. Desirably, the crosslinker is resole phenolic resin, isocyanate, or a mixture thereof.

Said resole phenolic resin contains the residues of un-substituted phenol and/or meta-substituted phenols. These particular resole resins exhibit good reactivity with said polyesteramide (a). Desirably, the amount of the resole phenolic resin is at least 50 wt. % or greater than 60 wt. % or greater than 70 wt. % or greater than 80 wt. % or greater than 90 wt. % based on the weight of all cross-linker compounds.

The resole phenolic resin present in the crosslinking composition contains methylol groups on the phenolic rings. Phenolic resins having methylol functionalities are referred to as resole type phenolic resins. As is known in the art, the methylol group (—CH₂OH) may be etherated with an alcohol and present as —CH₂OR, wherein R is C1-C8 alkyl group, in order to improve resin properties such as storage stability and compatibility. For purpose of the description, the term “methylol” used herein includes both —CH₂OH and —CH₂OR, and an un-substituted methylol group is CH₂OH. Said methylol groups (either —CH₂OH or —CH₂OR) are the end groups attached to the resole resins. The methylol groups are formed during the resole resin synthesis and can further react with another molecule to form ether or methylene linkages leading to macromolecules.

The phenolic resin contains the residues of un-substituted phenols or meta-substituted phenols. When starting with phenol or meta-substituted phenols to make a resole, the para and ortho positions are both available for bridging reactions to form a branched network with final methylol end groups on the resin being in the para or ortho positions relative to the phenolic hydroxyl group. To make the phenolic resole, a phenol composition is used as a starting material. The phenol composition contains un-substituted and/or meta-substituted phenols. The amount of un-substituted, meta-substituted, or a combination of the two, that is present in the phenol compositions used as a reactant to make the phenolic resole resin, is at least 50 wt. %, or at least 60 wt. %, or at least 70 wt. %, or at least 75 wt. %, or at least 80 wt. %, or at least 85 wt. %, or at least 90 wt. %, or at least 95 wt. %, or at least 98 wt. %, based on the weight of the phenol composition used as a reactant starting material.

The phenol composition is reacted with a reactive compound such as an aldehyde at an aldehyde: phenol molar ratio (using aldehyde as an example) of greater than 1:1, or at least 1.05:1, or at least 1.1:1, or at least 1.2:1, or at least 1.25:1, or at least 1.3:1, or at least 1.35:1, or at least 1.4:1, or at least 1.45:1, or at least 1.5:1, or at least 1.55:1, or at least 1.6:1, or at least 1.65:1, or at least 1.7:1, or at least 1.75:1, or at least 1.8:1, or at least 1.85:1, or at least 1.9:1, or at least 1.95:1, or at least 2:1. The upper amount of aldehyde is not limited and can be as high as 30:1, but generally is up to 5:1, or up to 4:1, or up to 3:1, or up to 2.5:1. Typically, the ratio of aldehyde:phenol is at least 1.2:1 or more, or 1.4:1 or more or 1.5:1 or more, and typically up to 3:1. Desirably, these ratios also apply to the aldehyde/unsubstituted phenol or meta-substituted phenol ratio.

The resole phenolic resin can contain an average of at least 0.3, or at least 0.4, or at least 0.45, or at least 0.5, or at least 0.6, or at least 0.8, or at least 0.9 methylol groups per one phenolic hydroxyl group, and “methylol” includes both —CH₂OH and —CH₂OR.

The phenolic resin obtained by the condensation of phenols with aldehydes of the general formula (RCHO)n, where R is hydrogen or a hydrocarbon group having 1 to 8 carbon atoms and n is 1, 2, or 3. Examples include formaldehyde, paraldehyde, acetaldehyde, glyoxal, propionaldehyde, furfuraldehyde, or benzaldehyde. Desirably, the phenolic resin is the reaction product of phenols with formaldehyde.

At least a part of the crosslinker in (b) comprises a resole type phenolic resin that is prepared by reacting either un-substituted phenol or meta-substituted phenol or a combination thereof with an aldehyde. The unsubstituted phenol is phenol (C₆H₅OH). Examples of meta-substituted phenols include m-cresol, m-ethylphenol, m-propylphenol, m-butylphenol, moctylphenol, m-alkylphenol, m-phenylphenol, m-alkoxyphenol, 3,5-xylenol, 3,5-diethyl phenol, 3,5-dibutyl phenol, 3,5-dialkylphenol, 3,5-dicyclohexyl phenol, 3,5-dimethoxy phenol, 3-alkyl-5-alkyoxy phenol, and the like.

Although other substituted phenol compounds can be used in combination with said un-substituted phenols or meta-substituted phenols for making phenolic resins, it is desirable that at least 50%, or at least 70%, or at least 80%, or at least 90%, or at least 95%, or at least 98%, or at least 100% of the phenolic compounds used to make the resole resin are unsubstituted phenol or meta-substituted phenol.

In one aspect, the resole phenolic resin used in this invention comprises residues of m-substituted phenol.

Examples of suitable commercial phenolic resins include, but are not limited to, PHENODUR® PR 516/60B (based on cresol and formaldehyde) available from Allnex, PHENODUR® PR 371/70B (based on unsubstituted phenol and formaldehyde) also available from Allnex, and CURAPHEN 40-856 B60 (based on m-cresol and formaldehyde) available from Bitrez.

The phenolic resins are desirably heat curable. The phenolic resin is desirably not made by the addition of bisphenol A, F, or S (collectively “BPA”).

The resole is desirably of the type that is soluble in alcohol. The resole resin can be liquid at 25° C. The resole resin can have a weight average molecular weight from 200 to 2000, generally from 300 to 1000, or from 400 to 800, or from 500 to 600.

The isocyanate crosslinker suitable for this invention may be blocked or unblocked isocyanate type. Examples of suitable isocyanate crosslinkers include, but are not limited to, 1,6-hexamethylene diisocyanate, methylene bis(4-cyclohexyl isocyanate), and isophorone diisocyanate. Desirably, the isocyanate crosslinker is isophorone diisocyanate (IPDI) or blocked IPDI available from COVESTRO as Desmodur® BL 2078/2.

In some embodiments, the crosslinker (b) is a mixture of CURAPHEN 40-856 B60 available from Bitrez and blocked isophorone diisocyanate (IPDI).

In another embodiment, the crosslinker (b) is a mixture of resole phenolic resin in an amount of 70-90 weight % and isocyanate in an amount of 10-30 weight %, based on the total weight of the crosslinkers.

In addition to resole phenolic resin and isocyanate, said crosslinker (b) may also be amino resin. The amino resin crosslinker (or cross-linking agent) can be a melamine-formaldehyde type or benzoguanamine-formaldehyde type cross-linking agent, i.e., a cross-linking agent having a plurality of —N(CH₂OR₃)₂ functional groups, wherein R³ is C1-C4 alkyl, preferably methyl.

In still another embodiment, the crosslinker (b) is a mixture of amino resin in an amount of 50-70 weight % and isocyanate in an amount of 30-50 weight %, based on the total weight of the crosslinkers.

In general, the amino cross-linking agent may be selected from compounds of the following formulae, wherein R³ is independently C1-C4 alkyl:

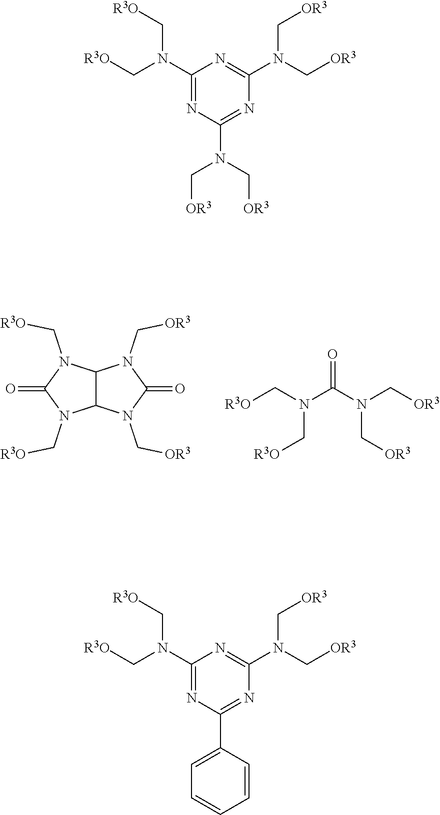

The amino cross-linking agents suitable for this invention are hexamethoxymethylmelamine, hexabutoxymethylmelamine, tetramethoxymethylbenzoguanamine, tetrabutoxymethylbenzoguanamine, tetramethoxymethylurea, mixed butoxy/methoxy substituted melamines, and the like. Further, amino resins having free amino (—NH2) or imino (—NH—CH2OR) groups may also be used for reacting with α,β-unsaturated groups on the polyesters to enhance crosslinking. Suitable commercial amino resins include Maprenal BF 987 (n-butylated benzoquanamine-formaldelhyde resin available from Ineos), Cymel 1123 (highly methylated/ethylated benzoguanamine-formaldehyde resin available from Allnex), Cymel 1158 (butylated melamine-formaldehyde resin with amino functionality available from Allnex), and other benzoquanamine-formaldelhyde and melamine-formaldehyde resins.

Desirably, in all the types of thermosetting compositions, the cross-linker composition contains greater than 50 wt. % or greater than 60 wt. % or greater than 70 wt. % or greater than 80 wt. % or greater than 90 wt. % resole phenolic resin, based on the weight of the cross-linker composition. In addition to or in the alternative, the remainder of the cross-linking compounds in the cross-linking composition, if any, are amine based crosslinking compounds as described above and/or isocyanate crosslinker.

Any of the thermosetting compositions of the invention can also include one or more cross-linking catalysts. Representative crosslinking catalysts include from carboxylic acids, sulfonic acids, tertiary amines, tertiary phosphines, tin compounds, or combinations of these compounds. Some specific examples of crosslinking catalysts include p-toluenesulfonic acid, phosphoric acid, the NACURE™ 155, 5076, 1051, and XC-296B catalysts sold by King Industries, BYK 450, 470, available from BYK-Chemie U.S.A., methyl tolyl sulfonimide, p-toluenesulfonic acid, dodecylbenzene sulfonic acid, dinonylnaphthalene sulfonic acid, and dinonylnaphthalene disulfonic acid, benzoic acid, triphenylphosphine, dibutyltindilaurate, and dibutyltindiacetate.

The crosslinking catalyst can depend on the type of crosslinker that is used in the coating composition. For example, the crosslinker can comprise a melamine or “amino” crosslinker and the crosslinking catalyst can comprise p-toluenesulfonic acid, phosphoric acid, unblocked and blocked dodecylbenzene sulfonic (abbreviated herein as “DDBSA”), dinonylnaphthalene sulfonic acid (abbreviated herein as “DNNSA”) and dinonylnaphthalene disulfonic acid (abbreviated herein as “DNNDSA”). Some of these catalysts are available commercially under trademarks such as, for example, NACURE™ 155, 5076, 1051, 5225 and XC-296B (available from King Industries), BYK-CATALYSTS™ (available from BYK-Chemie USA), and CYCAT™ catalysts (available from Cytec Surface Specialties). The coating compositions of the invention can comprise one or more isocyanate crosslinking catalysts such as, for example, FASCATT 4202 (dibutyltindilaurate), FASCATT 4200 (dibutyltindiacetate, both available from Arkema), DABCO™ T-12 (available from Air Products) and K-KAT™ 348, 4205, 5218, XC-6212™ non-tin catalysts (available from King Industries), and tertiary amines.

The coating composition can contain an acid or base catalyst in an amount ranging from 0.1 to 2 weight %, based on the total weight of any of the aforementioned curable polyester resins and the crosslinker composition.

In another embodiment, the coating composition of the present invention further comprises one or more organic solvents. Suitable organic solvents include xylene, ketones (for example, methyl amyl ketone), 2-butoxyethanol, ethyl-3-ethoxypropionate, toluene, butanol, cyclopentanone, cyclohexanone, ethyl acetate, butyl acetate, Aromatic 100 and Aromatic 150 (both available from ExxonMobil), and other volatile inert solvents typically used in industrial baking (i.e., thermosetting) enamels, mineral spirits, naptha, toluene, acetone, methyl ethyl ketone, methyl isoamyl ketone, isobutyl acetate, t-butyl acetate, n-propyl acetate, isopropyl acetate, methyl acetate, ethanol, n-propanol, isopropanol, sec-butanol, isobutanol, ethylene glycol monobutyl ether, propylene glycol n-butyl ether, propylene glycol methyl ether, propylene glycol monopropyl ether, dipropylene glycol methyl ether, diethylene glycol monobutyl ether, trimethylpentanediol mono-isobutyrate, ethylene glycol mono-octyl ether, diacetone alcohol, 2,2,4-trimethyl-1,3-pentanediol monoisobutyrate (available commercially from Eastman Chemical Company under the trademark TEXANOL™), or combinations thereof.

The amount of solvents is desirably at least 20 wt. %, or at least 25 wt. %, or at least 30 wt. %, or at least 35 wt. %, or at least 40 wt. %, or at least 45 wt. %, or at least 50 wt. %, or at least 55 wt. % based on the weight of the solvent containing coating composition. Additionally, or in the alternative, the amount of organic solvents can be up to 85 wt. % based on the weight of the coating composition.

In some embodiments of the invention, the coating has a solvent resistance as measured by the method of ASTM D7835 of greater than 50 MEK double rubs, or greater than 60 MEK double rubs, or greater than 70 MEK double rubs, or greater than 80 MEK double rubs, or greater than 90, or greater than 100 MEK double rubs.

In some embodiments of the invention the coating has a wedge bend resistance (% pass) of 70-100, 75-100, 80-100, 85-100, or 90-100 as measured by the method of ASTM D3281.

In further embodiments of the invention, the coating has a microcracking resistance rating (%) of 2.5-5, 3-5, 3.5-5, or 4-5 and a total retort resistance rating (%) of 70-100, 80-100, or 90-100, as measured by the methods specified in the Example section.

In another embodiment of the invention, the coating has an Erichsen cup test rating of 2-4, 2.5-4, 3-4, or 3.5-4 (before retort) as measured by the method specified in the example section.

In a model compound study, the present inventors have discovered that n-butyl propionamide is capable of reacting with Desmodur Z 4470, an isocyanate compound, through the functionalities of amide and isocyanate. Also discovered is the feasible reaction between n-butyl propionamide and 4,6-di-t-butyl-2-hydroxymethyl phenol, which represents resole phenolic resins. These discoveries are significant in that a linear polyesteramide of the present invention can react with an isocyanate or resole phenolic crosslinker through the amide group in the main chain in addition to the hydroxyl end groups resulting in more effective crosslinking and improved coating properties.

Examples of suitable catalysts for the reaction of amide group with isocyanate or resole phenolic resin include Fascat 9102 (butyltin tris-2-ethylhexanoate) available from PMC Group, Nacure 5076 (dodecylbenzene sulfonic acid) and Nacure XC-296 (an acid catalyst) available from King Industries. The order of the catalyst effectiveness for the reaction of amide and isocyanate is found to be Fascat 9102>Nacure 5076>Nacure XC-296, whereas for amide and resole phenolic resin, dodecybenzene sulfonic acid is found to be most effective.

In a further embodiment, this invention provides a coating composition for metal packaging application, which comprises:
a. a linear polyesteramide in an amount of 65-85 weight %, based on the total weight of (a), (b), and (c), which is the reaction product of the monomers comprising:
   i. 2,2,4,4-tetramethyl-1,3-cyclobutanediol (TMCD) in an amount of 35-45 mole %, based on the total moles of i-iv,
   ii. 1,4-cyclohexanedimethanol in an amount of 20-45 mole %, based on the total moles of i-iv,
   iii. 2-methyl-1,3-propanediol in an amount of 10-30 mole %, based on the total moles of i-iv,
   iv. an aliphatic diamine in an amount of 0.2-10 mole %, based on the total moles of i-iv,
   v. isophthalic acid in an amount of 60-80 mole %, based on the total moles of v-vii,
   vi. terephthalic acid in an amount of 20-40 mole %, based on the total moles of v-vii, and
   vii. an aliphatic diacid in an amount of 0-10 mole %, based on the total moles of v-vii, and
b. a resole phenolic resin in an amount of 8-30 weight % based on the total weight of (a), (b), and (c), and
c. isophorone diisocyanate (IPDI) in an amount of 3-15 weight % based on the total weight of (a), (b), and (c),
   wherein the linear polyesteramide has a glass transition temperature (Tg) of 70 to 90° C., acid number of 0 to 10 mgKOH/g, hydroxyl number of 5 to 15 mgKOH/g, number average molecular weight of 8,000 to 20,000 mgKOH/g, and weight average molecular weight of 20,000 to 100,000; and wherein said coating has MEK double rubs of 50 to 100 or greater as measured by the method of ASTM D7835 and a wedge bend resistance (% pass) of 70-100 as measured by the method of ASTM D3281.

Said polyesteramide has an inherent viscosity of 0.3-0.7, 0.4-0.7, 0.5-0.7, 0.6-0.7, 0.3-0.6, 0.4-0.6, 0.5-0.6, 0.3-0.5, 0.4-0.5, or 0.3-0.4 dL/g (determined at 25° C., using 0.5 weight % solution in 60/40 phenol/1, 1,2,2-tetrachloroethane by weight).

In a further embodiment, said coating has a microcrack resistance rating of 2.5-5 and a total retort resistance rating of 80-100, as measured by the methods specified in the example section.

In yet another embodiment, said coating has an Erichsen cup test rating of 2-4 (before retort) as measured by the method specified in the example section.

As a further aspect of the invention, said coating composition comprises a linear polyesteramide (a) in an amount of 70-85 weight %, a resole phenolic resin (b) in an amount of 11-25 weight, and isophorone diisocyanate (IPDI) (c) in an amount of 4-13 weight % based on the total weight of (a), (b), and (c), wherein said polysteramide has an inherent viscosity of 0.4 to 0.5 dL/g determined at 25° C., using 0.5 weight % solution in 60/40 phenol/1, 1,2,2-tetrachloroethane by weight. In another aspect, said coating exhibits one or more of the following properties: a solvent resistance of greater than 80 MEK double rubs as measured by ASTM D7835; and a wedge bend resistance (% pass) of 80-100 as measured by the method of ASTM D3281. In yet another aspect, said coating has an Erichsen cup test rating of 3.5-4 (before retort) and 3-4 (after retort) as measured by the method specified in the example section.

In another embodiment, this invention provides a coating composition for metal packaging application, which comprises:
a. a linear polyesteramide in an amount of 70-90 weight %, based on the total weight of (a) and (b), which is the reaction product of the monomers comprising:
   i. 2,2,4,4-tetramethyl-1,3-cyclobutanediol (TMCD) in an amount of 35-45 mole %, based on the total moles of i-iv,
   ii. 1,4-cyclohexanedimethanol in an amount of 20-45 mole %, based on the total moles of i-iv,
   iii. 2-methyl-1,3-propanediol in an amount of 10-30 mole %, based on the total moles of i-iv,
   iv. an aliphatic diamine in an amount of 0.2-10 mole %, based on the total moles of i-iv,
   v. isophthalic acid in an amount of 60-80 mole %, based on the total moles of v-vii,
   vi. terephthalic acid in an amount of 20-40 mole %, based on the total moles of v-vii, and
   vii. an aliphatic diacid in an amount of 0-10 mole %, based on the total moles of v-vii, and
b. isophorone diisocyanate (IPDI) in an amount of 10-30 weight % based on the total weight of (a) and (b),
   wherein the linear polyesteramide has a glass transition temperature (Tg) of 70 to 90° C., acid number of 0 to 10 mgKOH/g, hydroxyl number of 5 to 15 mgKOH/g, number average molecular weight of 8,000 to 20,000 mgKOH/g, and weight average molecular weight of 20,000 to 100,000; and wherein said coating has MEK double rubs of 50 to 100 or greater as measured by the method of ASTM D7835 and a wedge bend resistance (% pass) of 70-100 as measured by the method of ASTM D3281.

Said polyesteramide has an inherent viscosity of 0.3-0.7, 0.4-0.7, 0.5-0.7, 0.6-0.7, 0.3-0.6, 0.4-0.6, 0.5-0.6, 0.3-0.5, 0.4-0.5, or 0.3-0.4 dL/g (determined at 25° C., using 0.5 weight % solution in 60/40 phenol/1,1,2,2-tetrachloroethane by weight).

In a further embodiment, said coating has a microcrack resistance rating of 2.5-5 and a total retort resistance rating of 80-100, as measured by the methods specified in the example section.

In another embodiment, this invention provides a coating composition for metal packaging application, which comprises:
a. a branched polyesteramide in an amount of 65-85 weight %, based on the total weight of (a), (b), and (c) which is the reaction product of the monomers comprising:
   i. 2,2,4,4-tetramethyl-1,3-cyclobutanediol (TMCD) in an amount of 35-45 mole %, based on the total moles of i-v,
   ii. 1,4-cyclohexanedimethanol in an amount of 25-45 mole %, based on the total moles of i-v,
   iii. 2-methyl-1,3-propanediol in an amount of 5-30 mole %, based on the total moles of i-v,
   iv. an aliphatic diamine in an amount of 0.2-10 mole %, based on the total moles of i-v,
   v. a polyol in an amount of 1-5 mole %, based on the total moles of i-v,
   vi. isophthalic acid in an amount of 60-80 mole %, based on the total moles of vi-viii,
   vii. terephthalic acid in an amount of 20-40 mole %, based on the total moles of vi-viii, and
   viii. an aliphatic diacid in an amount of 0-10 mole %, based on the total moles of vi-viii,
b. a benzoguanamine-formaldehyde resin in an amount of 10-20 weight % based on the total weight of (a), (b), and (c), and
c. a melamine-formaldehyde resin in in an amount of 5-15 weight % based on the total weight of (a), (b), and (c),
   wherein the branched polyesteramide has a glass transition temperature (Tg) of 70 to 100° C., acid number of 0 to 10 mgKOH/g, hydroxyl number of 10 to 30 mgKOH/g, number average molecular weight of 8,000 to 20,000 mgKOH/g, and weight average molecular weight of 20,000 to 100,000.

In a further embodiment, said polyesteramide has an inherent viscosity of 0.2-0.5, 0.25-0.45, or 0.3-0.4 dL/g (determined at 25° C., using 0.5 weight % solution in 60/40 phenol/1, 1,2,2-tetrachloroethane by weight).

In yet another embodiment, said coating has a reverse impact resistance rating of 1.5-5 as measured by the methods specified in the example section.

In a further embodiment, the polyesteramide of the invention may be unsaturated, comprising an α,β-unsaturated diacid or anhydride. Examples of said α,β-unsaturated diacid or anhydride include maleic acid or its anhydride, crotonic acid or its anhydride, itaconic acid or its anhydride, citraconic acid or its anhydride, mesaconic acid, phenylmaleic acid or its anhydride, t-butyl maleic acid or its anhydride, and mixtures thereof. Desirably, said α,β-unsaturated diacid or anhydride (iv) is one or more selected from the group consisting of maleic anhydride, maleic acid, fumaric acid, itaconic anhydride, and itaconic acid. It should be noted that the aforementioned diacids include their monoesters and diesters such as, for example, dimethyl maleate and dimethyl fumarate.

Thus, this invention further provides a coating composition for metal packaging application, which comprises:
a. an unsaturated polyesteramide in an amount of 65-85 weight %, based on the total weight of (a) and (b), which is the reaction product of the monomers comprising:
   i. 2,2,4,4-tetramethyl-1,3-cyclobutanediol (TMCD) in an amount of 35-50 mole %, based on the total moles of i-iv,
   ii. 1,4-cyclohexanedimethanol in an amount of 20-40 mole %, based on the total moles of i-iv,
   iii. 2-methyl-1,3-propanediol in an amount of 10-30 mole %, based on the total moles of i-iv,
   iv. an aliphatic diamine in an amount of 0.2-15 mole %, based on the total moles of i-iv,
   v. isophthalic acid in an amount of 50-70 mole %, based on the total moles of v-viii,
   vi. terephthalic acid in an amount of 29-40 mole %, based on the total moles of v-viii,
   vii. an α,β-unsaturated dicarboxylic acid or anhydride in an amount of 1 to 15 mole %, based on the total moles of v-viii, and
   viii. an aliphatic diacid other than (vii) in an amount of 0-10 mole %, based on the total moles of v-viii,
b. a benzoguanamine-formaldehyde resin in an amount of 10-20 weight % based on the total weight of (a), (b), and (c), and
c. a melamine-formaldehyde resin in in an amount of 5-15 weight % based on the total weight of (a), (b), and (c),
wherein the unsaturated polyesteramide has a glass transition temperature (Tg) of 70 to 100° C., acid number of 0 to 10 mgKOH/g, hydroxyl number of 5 to 20 mgKOH/g, number average molecular weight of 8,000 to 20,000 mgKOH/g, and weight average molecular weight of 20,000 to 100,000.

In a further embodiment, said polyesteramide has an inherent viscosity of 0.3-0.7, 0.4-0.7, 0.5-0.7, 0.6-0.7, 0.3-0.6, 0.4-0.6, 0.5-0.6, 0.3-0.5, 0.4-0.5, or 0.3-0.4 dL/g (determined at 25° C., using 0.5 weight % solution in 60/40 phenol/1,1,2,2-tetrachloroethane by weight).

In yet another embodiment, said coating has MEK double rubs of 50 to 100 or greater as measured by the method of ASTM D7835 and a reverse impact resistance rating of 1.5-5 as measured by the methods specified in the example section.

The coating composition may also comprise at least one pigment. Typically, the pigment is present in an amount of about 10 to about 40 weight percent, based on the total weight of the composition. Examples of suitable pigments include titanium dioxide, barytes, clay, calcium carbonate, and CI Pigment White 6 (titanium dioxide). For example, the solvent-borne, coating formulations can contain titanium dioxide as the white pigment available from CHEMOURS as Ti-Pure™ R 900.

After formulation, the coating composition can be applied to a substrate or article. Thus, a further aspect of the present invention is a shaped or formed article that has been coated with the coating compositions of the present invention. The substrate can be any common substrate such as aluminum, tin, steel or galvanized sheeting; urethane elastomers; primed (painted) substrates; and the like. The coating composition can be coated onto a substrate using techniques known in the art, for example, by spraying, draw-down, roll-coating, etc., about 0.1 to about 4 mils (1 mil=25 μm), or 0.5 to 3, or 0.5 to 2, or 0.5 to 1 mils of wet coating onto a substrate. The coating can be cured at a temperature of about 50° C. to about 230° C., for a time period that ranges from about 5 seconds to about 90 minutes and allowed to cool. Examples of coated articles include metal cans for food and beverages, in which the interiors are coated with the coating composition of the present invention.

Thus, this invention further provides an article, of which at least a portion is coated with the coating composition of the present invention.

### EXAMPLES

This invention can be further illustrated by the following examples thereof, although it will be understood that these examples are included merely for purposes of illustration and are not intended to limit the scope of the invention unless otherwise specifically indicated.

### Abbreviations

mL is milliliter; wt % is weight percent; eq is equivalent(s); hrs or h is hour(s); mm is millimeter; m is meter; ° C. is degree Celsius; min is minute; g is gram; mmol is millimole; mol is mole; kg is kilogram; L is liter; w/v is weight/volume; μL is microliter; MW is molecular weight/

### Coating Test Methods

### Substrate, Coated Test Panel Preparation, Film Weight

Two types of electro tin plate (ETP) substrate panels were used. One panel from Lakeside Metals Inc. —0.23 mm thickness, 2.2 g/m² tin content, temper and annealing type T61CA, and one from Reynolds Metals Company-0.19 mm thickness, 2.2 g/m² tin content, temper and annealing type DR-8CA. The panels were coated with the formulations by casting wet films with wire wound rods, RDS 14 for pigmented and RDS 10 or 20 for gold (RDS 14, RDS 10 and RDS 20 are available from R.D. Specialties, Inc.). This yielded a final dry film weight of approximately 14-16 grams/m² for pigmented coatings and approximately 6-8 grams/m² using RDS 10 and 10-11 grams/m² using RDS 20 for coatings containing phenolic resin crosslinker, which showed gold color when cured (gold coatings). For microcracking test, the formulations were applied by casting wet films with wire wound rods—RDS 5 (available from R.D. Specialties, Inc.) which yielded a dry film weight of 3.0-3.5 gram/m². The cast panels were placed in a rack vertically. A Despatch forced air oven was preheated to a temperature of 203° C. The coated panels in the rack were then placed into the oven for 18 minutes of bake cycle time in order to allow the coatings to be baked at 200° C. Peak Metal Temperature (PMT) for 10 minutes. At the conclusion of the baking cycle, the panel rack was removed from the oven and allowed to cool to ambient temperature. A Sencon SI9600 coating thickness gauge was used to confirm the dry film weight of the applied coatings.

### Wedge Bend

A coupon measuring 1.25″ wide×4″ long was cut from a coated panel. This coupon was tested by a Gardco coverall bend and impact tester following ASTM D 3281. To make a bend test, the coated coupon was first bent over a ⅛″ (0.32 cm) steel rod. The bent coupon was placed between the parts of a butt hinge. The hinge made of two steel blocks is attached to the base below the guide tube. When the hinge is closed, it creates a wedge shape gap between the upper and lower parts ranging from ⅛″ at the hinged end to zero thickness at the free end. Then the impact tool, flat face down, was dropped from a height of one or two feet onto the upper part of the hinge. Once a coated coupon was bent and impacted into a wedge shape, it was then soaked in an acidified copper sulfate solution (5 wt % copper sulfate, 15 wt % hydrochloric acid (35%), 80 wt % distilled water) for 5 minutes to make any cracks in the coating visible. Excess copper sulfate solution was removed by washing with water and blotting with a dry towel. Wedge bend failure (mm), measured by using a ruler and a lighted magnifying glass, is defined as the total length of a continuous crack along the bent edge of the coupon. The result is reported as Pass % of wedge bend which is calculated by:

$$Pass \% of wedge bend = \frac{( Total length - wedge bend failure )}{Total length} \times 100 \%$$

Each Pass % of wedge bend in this experiment is an average value from 3 repeated tests.

### Methyl Ethyl Ketone (MEK) Double Rubs

The resistance to MEK solvent was measured using a MEK rub test machine (Gardco MEK Rub Test Machine AB-410103EN with 1 kg block). This test was carried out similar to ASTM D7835. MEK solvent resistance was reported as the number of double rubs a coated panel can withstand before the coating starts to be removed. For example, one back-and-forth motion constitutes one double rub. A maximum of 100 double rubs was set as the upper limit for each evaluation.

### Sterilization Resistance Testing

A coated coupon measuring 2.5″ wide×4″ long was cut from the coated panel. The coupons were then placed in a 16 oz wide mouth Le Parfait glass jar half filled with the food simulant where half the coupon is above food simulant liquid and the other half is submerged in food simulant liquid. Two different food simulants were evaluated:
Lactic acid: 2% lactic acid, 98% deionized water.
Acetic Acid: 3% acetic acid, 97% deionized water.

The jars with properly closed top were placed in an autoclave, Priorclave Model PNA/QCS/EH150, for 1 hr at 131° C. Once the retort process was finished, the autoclave was allowed to depressurize to ambient conditions. After the completion of sterilization cycle, the glass jars containing the test coupons were then removed from the autoclave. The coupons were removed from the jars and washed under water and blotted dry with paper towels. The retort performance is rated on a scale of 0 (worst) to 5 (best) using a visual observation. For each food simulant, the retort performance was rated on (1) blush at vapor phase, (2) blush at liquid phase, (3) roughness at vapor phase, (4) roughness at liquid phase and (5) cross-hatch adhesion (following ASTM D 3359) at liquid phase, respectively. An overall retort performance is reported as Total Retort % calculated by:

$$Total Retort \% = \frac{\begin{matrix}Sum of rating ( 1 ) to ( 5 ) from 2 \% lactic acid + \\ Sum of rating ( 1 ) to ( 5 ) from 3 \% acetic acid\end{matrix}}{50} \times 100 \%$$

Each retort rating in this experiment is an average rating from 2 replicates.

### Microcracking Test

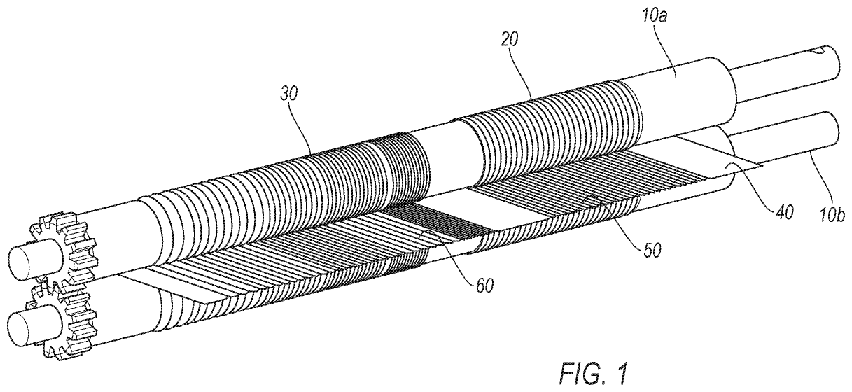

To execute the micro-cracking test, a beading pattern was created on a coated panel to simulate the fabrication of metal cans. As shown in FIG. 1, a coated panel (40) with a dimension of 1″×4″ was inserted into the gap between the two rollers (10a and 10b) of a modified Metal Bead Roller and followed by a deformation process as running through the roller. With the function of a die, the two rollers with a large array of beading ripples (20 and 30) reproduce the beading patterns (50 and 60) from a range of can sizes (from 4 oz to 3 kg). The gap between the rollers was adjusted corresponding to the thickness of the tinplate. The film weight of coatings for this test was in a range of 3.0-3.5 gram/m². After the beading process, the uncoated area of a panel including the edges and the backside were covered by vinyl tape (Yellow Heat Treated 3M 471), and followed by a 45 minutes immersion in acidified copper sulfate solution which stained any area where cracking or micro-cracking occurred on the coating due to the process. Acidified copper sulfate solution used in the experiment consisted of 16 wt % copper sulfate, 5 wt % hydrochloric acid (35%), 79 wt % distilled water. All samples were taken out from copper sulfate solution, rinsed with water, dried with a paper towel, and evaluated for stain on a 1 to 5 scale with 5 being 0% stained area, 1 being ≥50% stained area, and 0.5 interval on rating for every 5% change on stained area. Each rating for microcracking test in this experiment is an average rating from 2 repeated tests.

### Erichsen Cupping and Deep-Draw Cup Test (Erichsen Cup Test)

The Erichsen cupping and deep-draw cup test (also known as Erichsen Cup test) was performed by operating Lacquer and Paint Testing Machine Model 212 purchased from Erichsen, Inc (Westlake, Ohio). To prepare the test, the die, specimen holder and coating surface were lubricated with beef fat. A lubricated coated panel with a dimension of 1″×4″ (with coated side facing up) was inserted into “Specimen Opening” of the machine, followed by centering lubricated area of the panel over the die and deep drawing process as programmed by the machine. The Move Speed Dial was set to 4 and Draw Height was set to 25.6 mm.

After the cup was made, the beef fat lubricant was wiped off from the sample surface using a soft dry paper towel. The resulting cup samples with 4 corners was scribed with “X” mark on each corner and followed by fully submerged retort process for 1 hr at 131° C. in 3% acetic acid food simulant. After retort, all cups were taken out from the jar, rinsed with water, carefully dried with a paper towel, and evaluated visually. The coating performance is evaluated by the number of survived corners—from 0 survived corners being worst to all 4 survived corners being best. A survived corner is identified as coating is adhered to the corner without visible delamination or corrosion at “X” mark. Each evaluation for Erichsen cup test in this experiment is an average rating from 2 repeated tests.

### Substrate, Coated Test Panel Preparation, Film Weight (Clear Formulations)

The clear coatings were applied on zirconium treated aluminum substrate—0.208 mm thickness, A42S alloy and H29 temper by casting wet films with wire wound rods—RDS 20 (available from R.D. Specialties, Inc.). This yielded a final dry film weight to achieve approximately 10-11 gram/m². A Despatch forced air oven was preheated to a setting temperature of 350° C. The coated panels were then placed into the oven for 32 seconds of bake cycle time in order to allow the coatings to be baked at 240° C. Peak Metal Temperature (PMT) for 10 seconds. In conclusion of baking cycle, the panel was removed from the oven and allowed to cool back to ambient conditions. A Sencon SI9600 coating thickness gauge was used to confirm the dry film weight of the applied coating.

### Reverse Impact Testing

The reverse impact test was carried out using an impact tester from Gardco. A coupon measuring 3″×8″ was cut from a coated panel. On the reverse side of the panel (uncoated side) three test squares were drawn well distributed down the center of the panel and the central point of each square was marked to know where to direct point of impact. The central point of square was aligned below the 2 lb dart and released from height of 19 cm. A piece of tape Scotch® Packaging Tape 610 was applied vertically across the impact zone on the coated side of the panel. A paper towel was saturated in 5% copper sulfate solution to blot impact zone to help highlight where adhesion loss occurred, and the substrate is exposed. The panels were then evaluated for adhesion loss and rated using 1-5 scale with those exhibiting a 5 having the best performance.

### Example 1: Synthesis of Branched Polyesteramide Containing 5% HDA (Resin 1)

This example illustrates the synthesis of polyesteramide containing 8 mole % of a branching agent, trimethylolpropane (TMP), and 2 mole % of 1,6-hexamethylene diamine (HAD).

The polyols were produced using a resin kettle reactor controlled with automated control software. The compositions were produced on a 3.5 mole scale using a 2 L kettle with overhead stirring and a partial condenser topped with total condenser and Dean Stark trap. Approximately 10 wt % (based on reaction yield) azeotroping solvent of high boiling point Aromatic 150ND (A150ND, available from ExxonMobil) was used to both encourage egress of the water condensate out of the reaction mixture and keep the reaction mixture from becoming excessively viscous using the standard paddle stirrer. Isophthalic acid (IPA), terephthalic acid (TPA), adipic acid (AD), 1,4-cyclohexane dimethanol (CHDM), 2,2,4,4-tetramethyl-1,3-cyclobutanediol (TMCD), 2-methyl-1,3-propanediol (MPdiol), trimethylolpropane (TMP), diamine monomer, and Aromatic 150 were added to the reactor. Fascat 4100 (monobutyltin oxide, available from PMC Organometallix Inc., 400 ppm) or the stock solution of titanium isopropoxide (TTIP, available from MilliporeSigma Inc., 160 ppm) in A150ND was added via the sampling port after the reactor had been assembled and blanketed with nitrogen for the reaction. Additional A150/A150ND solvent was added to the Dean Stark trap to maintain the ˜10 wt % solvent level in the reaction kettle. The reaction mixture was heated without stirring from room temperature to 150° C. using a set output controlled through the automation system. Once the reaction mixture was fluid, the stirring was started to encourage even heating of the mixture. At 150° C., the control of heating was switched to automated control and the temperature was ramped to 230° C. over the course of 4 hours. The reaction was held at 230° C. for 1 hour and then heated to 240° C. over the course of 1 hour. The reaction was then held at 240° C. and sampled every 0.5-1 hour upon clearing until the desired acid value was reached. The reaction mixture was then further diluted with A150ND or other solvents (MAK, benzyl alcohol) to target a weight percent solid of 50%. This solution was filtered through a ˜250 μm paint filter prior to use in the formulation and application testing. It should be noted that the glycol excesses were determined empirically for the lab reactor and may be different depending on the partial condenser and reactor design used. The raw materials are shown in Table 1.

TABLE 1
Charge

| | | | | Charge | |
|---|---|---|---|---|---|
| | | | | Weight | |
| Raw | | | | (including | % |
| Material | Moles | Equivalents | Weight | excess) | Excess |
| Stage 1 | | | | | |
| IPA | 2.1000 | 4.2000 | 348.87 | 348.87 | 0 |
| TPA | 0.7000 | 1.4000 | 116.29 | 116.29 | 0 |
| Adipic Acid | 0.7000 | 1.4000 | 102.27 | 102.27 | 0 |
| TMCD | 1.3926 | 2.7853 | 200.83 | 210.87 | 5 |
| 1,4-CHDM | 0.9395 | 1.8789 | 135.48 | 136.84 | 1 |
| MPdiol | 0.8732 | 1.7463 | 78.67 | 79.46 | 1 |
| HDA | 0.1842 | 0.3684 | 21.41 | 21.62 | 1 |
| TMP | 0.2947 | 0.8842 | 39.54 | 39.94 | 1 |
| | | Total Charge | 1056.16 | | |
| | | Minus | 124.81 | | |
| | | Condensate | | | |
| | | Yield | 931.35 | | |
| | Concen- | | | | |
| (Catalyst) | tration | | | | |
| Fascat 4100 | 400 | | | 0.74 | |
| (Processes | | | | | |
| Solvent) | Wt. % | | | | |
| A150ND | 10 | | | 117.43 | |

### Example 2: Synthesis of Polyesteramides Having Various Ratios of HDA (Resins 2-4)

Using the same method as above, resins 2-4 were also synthesized by using HDA ratios of 5 mole %, 10 mole %, and 20 mole %, respectively. Table 2 lists the compositions of Resins 1-4, and Table 3 lists their resin properties.

Glass transition temperature (Tg) was determined using a Q2000 differential scanning calorimeter (DSC) from TA Instruments, New Castle, DE, US, at a scan rate of 20° C./min. Number average molecular weight (Mn) and weight average molecular weight (Mw) Mn were measured by gel permeation chromatography (GPC) using polystyrene equivalent molecular weight and dichloromethane/hexafluoroisopropanol (95/5) solvent. Acid number was measured by using a procedure based on ASTM D7253-1 entitled “Standard Test Method for Polyurethane Raw Materials: Determination of Acidity as Acid Number for Polyether Polyols,” and hydroxyl number was measured using a procedure based on ASTM E222-1 entitled “Standard Test Methods for Hydroxyl Groups Using Acetic Anhydride.”

TABLE 2
Synthesized Polyesteramides Having Various Ratios of HDA

| | Resin Composition as Charged | | | | | | | |
|---|---|---|---|---|---|---|---|---|
| | Mole Ratio Based on Total Alcohols (%) | | | | | Mole Ratio Based | | |
| | | 1,4- | | | | on Total Acids (%) | | |
| | TMCD | CHDM | MPdiol | TMP | HDA | TPA | IPA | AD |
| Resin 1 | 39.1 | 26.4 | 24.5 | 8 | 2 | 60 | 20 | 20 |
| Resin 2 | 37.8 | 25.5 | 23.7 | 8 | 5 | 60 | 20 | 20 |
| Resin 3 | 35.7 | 24.0 | 22.3 | 8 | 10 | 60 | 20 | 20 |
| Resin 4 | 31.3 | 21.1 | 19.6 | 8 | 20 | 60 | 20 | 20 |

TABLE 3
Resin Properties of Polyesteramides

| | | | | | | Acid | OH | |
|---|---|---|---|---|---|---|---|---|
| | | | | | | Number | Number | Solubility |
| | Tg, ° C. | Mn | Mw | PDI | IV | Analyzed | Analyzed | (50% solids) |
| Resin 1 | 49 | 7218 | 31001 | 4.30 | 0.273 | 5 | 43 | Soluble in |
| | | | | | | | | A150ND |
| Resin 2 | 57 | 9809 | 61547 | 6.28 | 0.378 | 2 | 35 | Hazy |
| | | | | | | | | solution in |
| | | | | | | | | A150ND |
| Resin 3 | 58 | 7567 | 38186 | 5.05 | 0.325 | 5 | 43 | Hazy |
| | | | | | | | | solution in |
| | | | | | | | | A150ND |
| Resin 4 | 67 | 9028 | 98464 | 10.91 | 0.381 | 6 | 33 | Gelation in |
| | | | | | | | | A150ND |

### Example 3: Synthesis of Polyesteramides Using Various Diamines (Resins 5-7)

Using the same method as above, resins 5-7 were synthesized by using 2-methyl-1,5-pentanediamine (MPDA) and 4,4′-methylenebis(2-methylcyclohexylamine) (MACM) respectively. Table 4 lists the compositions of Resins 5-7, and Table 4 lists their resin properties.

TABLE 4
Synthesized Polyesteramides Using Various Diamines

| | Resin Composition as Charged | | | | | | | |
|---|---|---|---|---|---|---|---|---|
| | | | | | | Mole Ratio Based on | | |
| | Mole Ratio Based on Total Alcohols (%) | | | | | Total Acids (%) | | |
| | TMCD | 1,4-CHDM | MPdiol | TMP | Diamine | TPA | IPA | AD |
| Resin 5 | 39.1 | 26.4 | 24.5 | 8 | 2 (MPDA) | 60 | 20 | 20 |
| Resin 6 | 37.8 | 25.5 | 23.7 | 8 | 5 (MPDA) | 60 | 20 | 20 |
| Resin 7 | 40 | 22 | 25 | 8 | 5 (MACM) | 60 | 20 | 20 |

TABLE 5
Resin Properties of Polyesteramides

| | | | | | | Acid | OH | |
|---|---|---|---|---|---|---|---|---|
| | | | | | | Number | Number | Solubility |
| | Tg, ° C. | Mn | Mw | PDI | IV | Analyzed | Analyzed | (50% solids) |
| Resin 5 | 52.1 | 7947 | 37898 | 4.77 | 0.276 | 2.7 | 43 | Soluble in |
| | | | | | | | | A150ND |
| Resin 6 | 57.7 | 8229 | 37879 | 4.60 | 0.306 | 3.6 | 45 | Hazy solution |
| | | | | | | | | in A150ND |
| Resin 7 | 62.0 | 6740 | 28561 | 4.24 | 0.233 | 5.0 | 44 | Soluble in |
| | | | | | | | | A150ND |

### Example 4: Synthesis of Polyesteramides Having Various Ratios of HDA and Linear Structures (Resins 8-10)

Using the same method as above, resins 8-10 having linear structures were also synthesized by using HDA ratios of 2 mole %, 5 mole %, and 10 mole %, respectively. Table 6 lists the compositions of Resins 8-10, and Table 7 lists their resin properties.

TABLE 6
Synthesized Polyesteramides Having Various
Ratios of HDA and Linear Structures

| | Resin Composition as Charged | | | | | |
|---|---|---|---|---|---|---|
| | Mole Ratio Based on Total Alcohols (%) | | | | Mole Ratio Based | |
| | | 1,4- | | | on Total Acids (%) | |
| | TMCD | CHDM | HDO | HDA | TPA | IPA |
| Resin 8 | 39.2 | 39.2 | 19.6 | 2 | 30 | 70 |
| Resin 9 | 38 | 38 | 19 | 5 | 30 | 70 |
| Resin 10 | 36 | 36 | 18 | 10 | 30 | 70 |

TABLE 7
Resin Properties of Polyesteramides

| | | | | | | Acid | OH | Solubility |
|---|---|---|---|---|---|---|---|---|
| | Tg, ° | | | | | Number | Number | (50% |
| | C. | Mn | Mw | PDI | IV | Analyzed | Analyzed | solids) |
| Resin 8 | 76 | 9998 | 22096 | 2.21 | 0.298 | 5 | 16 | Soluble in |
| | | | | | | | | A150ND |
| Resin 9 | 78 | 9902 | 22676 | 2.29 | 0.306 | 4 | 13 | Soluble in |
| | | | | | | | | A150ND |
| Resin 10 | 82 | 12386 | 29603 | 2.39 | 0.369 | 5 | 9 | Soluble in |
| | | | | | | | | A150ND/MAK |
| | | | | | | | | (82%/18% |
| | | | | | | | | w/w) |

### Example 5: Synthesis of Polyesteramides Having High MW, Various Ratios of HDA and Branched Structures (Resins 11-17)

Using the same method as above, resins 11-17 having relatively higher MW were also synthesized by using various ratios of HDA from 1 mole % to 10 mole %. Table 8 lists the compositions of Resins 11-17, and Table 9 lists their resin properties.

TABLE 8
Synthesized Polyesteramides Having High MW,
Various Ratios of HDA and Branched Structures

| | Resin Composition as Charged | | | | | | | |
|---|---|---|---|---|---|---|---|---|
| | Mole Ratio Based on Total Alcohols (%) | | | | | Mole Ratio Based | | |
| | | 1,4- | | | | on Total Acids (%) | | |
| | TMCD | CHDM | MPdiol | TMP | HDA | TPA | IPA | AD |
| Resin 11 | 40 | 38 | 20 | 1 | 1 | 30 | 65 | 5 |
| Resin 12 | 40 | 39 | 18 | 1 | 2 | 30 | 65 | 5 |
| Resin 13 | 40 | 39 | 18 | 1 | 2 | 30 | 65 | 5 |
| Resin 14 | 40 | 39 | 18 | 1 | 2 | 30 | 65 | 5 |
| Resin 15 | 38.5 | 36.5 | 19 | 1 | 5 | 30 | 65 | 5 |
| Resin 16 | 38.5 | 36.5 | 19 | 1 | 5 | 30 | 65 | 5 |
| Resin 17 | 36.5 | 34.5 | 19 | 1 | 10 | 30 | 65 | 5 |

TABLE 9
Resin Properties of Polyesteramides

| | | | | | | Acid | OH | Solubility |
|---|---|---|---|---|---|---|---|---|
| | Tg, ° | | | | | Number | Number | (50% |
| | C. | Mn | Mw | PDI | IV | Analyzed | Analyzed | solids) |
| Resin 11 | 86 | 13850 | 39820 | 2.88 | 0.381 | 2.9 | 15 | Soluble in |
| | | | | | | | | A150ND |
| Resin 12 | 74 | 14211 | 35812 | 2.52 | 0.347 | 2.0 | 11 | Soluble in |
| | | | | | | | | A150ND |
| Resin 13 | 82 | 15796 | 44131 | 2.79 | 0.422 | 1.8 | 12 | Soluble in |
| | | | | | | | | A150ND |
| Resin 14 | 87 | 20926 | 80009 | 3.82 | 0.583 | 3.2 | 7 | Soluble in |
| | | | | | | | | A150ND |
| Resin 15 | 81 | 9971 | 25893 | 2.60 | 0.301 | 3.3 | 17 | Soluble in |
| | | | | | | | | A150ND |
| Resin 16 | 81 | 14535 | 40282 | 2.77 | 0.402 | 2.0 | 14 | Soluble in |
| | | | | | | | | A150ND |
| Resin 17 | 87 | 10734 | 30089 | 2.80 | 0.353 | 4.2 | 14 | Soluble in |
| | | | | | | | | A150ND |

### Example 6: Synthesis of Polyesteramides Having High MW, Various Ratios of HDA and Linear Structures (Resins 18-19)

Using the same method as above, resins 21-22 having relatively higher MW were also synthesized by using HDA ratios of 2 mole % and 5 mole %, respectively. Table 10 lists the compositions of Resins 18-19, and Table 10 lists their resin properties.

TABLE 10
Synthesized Polyesteramides Having High MW,
Various Ratios of HDA and Linear Structures

| | Resin Composition as Charged | | | | | | |
|---|---|---|---|---|---|---|---|
| | Mole Ratio Based on Total Alcohols (%) | | | | Mole Ratio Based | | |
| | | 1,4- | | | on Total Acids (%) | | |
| | TMCD | CHDM | MPdiol | HDA | TPA | IPA | AD |
| Resin 18 | 40 | 38 | 20 | 2 | 30 | 65 | 5 |
| Resin 19 | 39 | 37 | 19 | 5 | 30 | 65 | 5 |

TABLE 11
Resin Properties of Polyesteramides

| | | | | | | Acid | OH | Solubility |
|---|---|---|---|---|---|---|---|---|
| | Tg, ° | | | | | Number | Number | (50% |
| | C. | Mn | Mw | PDI | IV | Analyzed | Analyzed | solids) |
| Resin 18 | 81 | 17358 | 40068 | 2.31 | 0.430 | 1.4 | 8 | Soluble in |
| | | | | | | | | A150ND |
| Resin 19 | 82 | 13988 | 31952 | 2.28 | 0.370 | 2.0 | 11 | Soluble in |
| | | | | | | | | A150ND |

### Example 7: Synthesis of Polyesteramides Having High MW and Unsaturation (Resins 20-21)

Using the same method as above, resins 20-21 were also synthesized by using HDA ratios of 2 mole % and with branched or linear structures, respectively. Table 12 lists the compositions of Resins 20-21, and Table 13 lists their resin properties.

TABLE 12
Synthesized Polyesteramides Having High MW and Unsaturation

| | Resin Composition as Charged | | | | | | | | |
|---|---|---|---|---|---|---|---|---|---|
| | Mole Ratio Based on Total Alcohols (%) | | | | | Mole Ratio Based | | | |
| | | 1,4- | | | | on Total Acids (%) | | | |
| | TMCD | CHDM | MPdiol | TMP | HDA | TPA | IPA | AD | MA |
| Resin 20 | 40 | 38 | 19 | 1 | 2 | 28 | 62 | 5 | 5 |
| Resin 21 | 40 | 38 | 20 | — | 2 | 28 | 62 | 5 | 5 |

TABLE 13
Resin Properties of Polyesteramides

| | | | | | | Acid | OH | Solubility |
|---|---|---|---|---|---|---|---|---|
| | Tg, ° | | | | | Number | Number | (50% |
| | C. | Mn | Mw | PDI | IV | Analyzed | Analyzed | solids) |
| Resin 20 | 82 | 14124 | 44499 | 3.15 | 0.415 | 2.5 | 14 | Soluble in |
| | | | | | | | | A150ND |
| Resin 21 | 81 | 15746 | 41061 | 2.61 | 0.439 | 1.9 | 11 | Soluble in |
| | | | | | | | | A150ND |

### Example 8: Preparation of Gold Coating Formulation A Based on Resin 1, 5 and 7 (GFA-1, GFA-5 and GFA-7)

Coating formulation A intended for gold color were prepared by using Resins 1, 5 and 7. The gold formulations (GFA-1, GFA-5 and GFA-7) prepared from Resins 1, 5 and 7, respectively are listed in Table 14.

Prior to formulating, all polyesteramides were diluted in A150 ND to 50 wt. % solids. The solvent blends were made from the mixture of xylene, butanol and MAK at 30%, 30% and 40% by weight, respectively. An empty glass jar with a lid was labeled and pre-weighted to record the tare weight. For each formulation, Curaphen 40-856-B60, Desmodur® BL 2078/2, Nacure® XC-296B and the solvent blend were weighed out respectively and added to the resin solution in order. The formulation was then sheared for 10-15 minutes at 1500 RPMs with a Cowles blade on a Dispermat™ high speed disperser. Once it was completed, the glass jar containing the formulation was then rolled overnight with slight agitation at ambient conditions.

A food grade approved Desmodur® BL 2078/2 available from Covestro AG, and Curaphen 40-856-B60 available from Bitrez were chosen as blocked IPDI trimer and m-cresol phenolic-formaldehyde resin crosslinkers, respectively. A food grade approved Nacure® XC-296B available from King Industrials was chosen as H₃PO₄ catalyst.

TABLE 14
Gold Coating Formulation A Based on Resins 1, 5 and 7

| | Solids/ | GFA-1 | GFA-5 | GFA-7 |
|---|---|---|---|---|
| Component | Active % | Weight (g) | Weight (g) | Weight (g) |
| Resin 1 | 50% | 58.50 | | |
| Resin 5 | 50% | | 58.50 | |
| Resin 7 | 50% | | | 58.50 |
| Curaphen 40-856- | 60% | 18.75 | 18.75 | 18.75 |
| B60 | | | | |
| Desmodur ® BL | 60% | 7.50 | 7.50 | 7.50 |
| 2078/2 | | | | |
| Nacure ® XC-296B | 28% | 1.80 | 1.80 | 1.80 |
| BYK 392 | 52% | 0.5 | 0.5 | 0.5 |
| Solvent Blend | 0% | 12.95 | 12.95 | 12.95 |
| (Xylene, Butanol, | | | | |
| MAK 30/30/40) | | | | |

| | | | |
|---|---|---|---|
| Total | 100.00 | 100.00 | 100.00 |

Calculation:

| | | | |
|---|---|---|---|
| % Total solids binder | 45.00% | 45.00% | 45.00% |
| % Polyesteramide on total binder | 65.00% | 65.00% | 65.00% |
| % IPDI on total binder | 10.00% | 10.00% | 10.00% |
| % Phenolic on total binder | 25.00% | 25.00% | 25.00% |
| % H3PO4 as is on binder | 4% | 4% | 4% |

### Example 9: Coating Properties of Gold Coating Formulation A Based on Resin 1, 5 and 7 (GFA-1, GFA-5 and GFA-7)

The formulations prepared from Example 8 were applied on tin panels available from Reynolds Metals Company-0.19 mm thickness, 2.2 g/m² tin content, temper and annealing type DR-8CA (described as Reynolds substrate) by casting wet films with wire wound rods—RDS 10 (available from R.D. Specialties, Inc.). This yielded a final dry film weight to achieve approximately 6-8 grams/m². The cast panels were placed in a rack and held vertically in an oven for cure. A Despatch forced air oven was preheated to a setting temperature of 203° C. The coated panels in the rack were then placed into the oven for 18 minutes of bake cycle time in order to allow the coatings to be baked at 200° C. Peak Metal Temperature (PMT) for 10 minutes. In conclusion of baking cycle, the panel rack was removed from oven and allowed to cool to ambient conditions. A Sencon SI9600 coating thickness gauge was used to confirm the dry film weight of the applied coating. Once the coatings were made, coating performance tests including MEK Double Rubs, Wedge Bend and Sterilization Resistance Testing were performed on them. The results are shown in Table 15.

TABLE 15
Coating Properties of Gold Formulation
A based on Resin1, 5 and 7

| | | Pass % of | |
|---|---|---|---|
| Examples | MEK Double Rubs | wedge bend | Total Retort % |
| GFA-1 | 100+ | 74% | 92% |
| GFA-5 | 100+ | 76% | 87% |
| GFA-7 | 100+ | 80% | 84% |

### Example 10: Preparation of Gold Coating Formulation B Based on Resin 8-21 (GFB-8 to GFB-21)

Coating formulation B intended for gold color were prepared by using Resins 8-21. The gold formulations (GFB-8 to GFB-21) prepared from Resins 8 to Resin 21, respectively are listed in Table 16, Table 17 and Table 18.

Prior to formulating, all polyesteramides were diluted in A150 ND to 50 wt. % solids. The solvent blends were made from the mixture of xylene, butanol and MAK at 30%, 30% and 40% by weight, respectively. An empty glass jar with a lid was labeled and pre-weighted to record the tare weight. For each formulation, Curaphen 40-856-B60, Lanco™ Glidd 4415, Desmodur® BL 2078/2, Nacure® XC-296B and the solvent blend were weighed out respectively and added, in order, to the resin solution, while stirring with Dispermat™ high speed disperser. The formulation was then sheared for 10-15 minutes at 1500 RPMs with a Cowles blade on a Dispermat™ high speed disperser. Once it was completed, the glass jar containing the formulation was then rolled overnight with slight agitation at ambient conditions.

A food grade approved Desmodur® BL 2078/2 available from Covestro AG, and Curaphen 40-856-B60 available from Bitrez were chosen as blocked IPDI trimer and m-cresol phenolic-formaldehyde resin crosslinkers, respectively. A food grade approved Nacure® XC-296B available from King Industrials was chosen as H₃PO₄ catalyst. A food grade approved Lanco™ Glidd 4415 from Lubrizol was chosen as wax.

TABLE 16
Gold Coating Formulation B Based on Resins 8-11

| | | GFB-8 | GFB-9 | GFB-10 | GFB-11 |
|---|---|---|---|---|---|
| | Solids/ | Weight | Weight | Weight | Weight |
| Component | Active % | (g) | (g) | (g) | (g) |
| Resin 8 | 50% | 33.75 | | | |
| Resin 9 | 50% | | 33.75 | | |
| Resin 10 | 50% | | | 33.75 | |
| Resin 11 | 50% | | | | 33.75 |
| Lanco ™ Glidd | 15% | 1.00 | 1.00 | 1.00 | 1.00 |
| 4415 | | | | | |
| Curaphen 40- | 60% | 7.50 | 7.50 | 7.50 | 7.50 |
| 856-B60 | | | | | |
| Desmodur ® BL | 60% | 1.88 | 1.88 | 1.88 | 1.88 |
| 2078/2 | | | | | |
| Nacure ® XC- | 28% | 0.11 | 0.11 | 0.11 | 0.11 |
| 296B | | | | | |
| Solvent Blend | 0% | 5.76 | 5.76 | 5.76 | 5.76 |
| (Xylene, Butanol, | | | | | |
| MAK 30/30/40) | | | | | |

| | | | | |
|---|---|---|---|---|
| Total | 50.00 | 50.00 | 50.00 | 50.00 |

Calculation:

| | | | | |
|---|---|---|---|---|
| % Total solids binder | 45.00% | 45.00% | 45.00% | 45.00% |
| % Polyesteramide on total binder | 75.00% | 75.00% | 75.00% | 75.00% |
| % IPDI on total binder | 5.00% | 5.00% | 5.00% | 5.00% |
| % Phenolic on total binder | 20.00% | 20.00% | 20.00% | 20.00% |
| % H3PO4 as is on binder | 0.50% | 0.50% | 0.50% | 0.50% |

TABLE 17
Gold Coating Formulation B Based on Resins 12-16

| | | GFB-12 | GFB-13 | GFB-14 | GFB-15 | GFB-16 |
|---|---|---|---|---|---|---|
| | Solids/ | Weight | Weight | Weight | Weight | Weight |
| Component | Active % | (g) | (g) | (g) | (g) | (g) |
| Resin 12 | 50% | 33.75 | | | | |
| Resin 13 | 50% | | 33.75 | | | |
| Resin 14 | 50% | | | 33.75 | | |
| Resin 15 | 50% | | | | 33.75 | |
| Resin 16 | 50% | | | | | 33.75 |
| Lanco ™ Glidd | 15% | 1.00 | 1.00 | 1.00 | 1.00 | 1.00 |
| 4415 | | | | | | |
| Curaphen | 60% | 7.50 | 7.50 | 7.50 | 7.50 | 7.50 |
| 40-856-B60 | | | | | | |
| Desmodur ® BL | 60% | 1.88 | 1.88 | 1.88 | 1.88 | 1.88 |
| 2078/2 | | | | | | |
| Nacure ® XC-296B | 28% | 0.11 | 0.11 | 0.11 | 0.11 | 0.11 |
| Solvent Blend | 0% | 5.76 | 5.76 | 5.76 | 5.76 | 5.76 |
| (Xylene, Butanol, | | | | | | |
| MAK 30/30/40) | | | | | | |

| | | | | | |
|---|---|---|---|---|---|
| Total | 50.00 | 50.00 | 50.00 | 50.00 | 50.00 |

Calculations:

| | | | | | |
|---|---|---|---|---|---|
| % Total solid binder | 45.00% | 45.00% | 45.00% | 45.00% | 45.00% |
| % Polyesteramide on | 75.00% | 75.00% | 75.00% | 75.00% | 75.00% |
| total binder | | | | | |
| % IPDI on total binder | 5.00% | 5.00% | 5.00% | 5.00% | 5.00% |
| % Phenolic on total binder | 20.00% | 20.00% | 20.00% | 20.00% | 20.00% |
| % H3PO4 as is on binder | 0.50% | 0.50% | 0.50% | 0.50% | 0.50% |

TABLE 18
Gold Coating Formulation B Based on Resin 18-21

| | | GFB-18 | GFB-19 | GFB-20 | GFB-21 |
|---|---|---|---|---|---|
| | Solids/ | Weight | Weight | Weight | Weight |
| Component | Active % | (g) | (g) | (g) | (g) |
| Resin 18 | 40% | 37.50 | | | |
| Resin 19 | 40% | | 37.50 | | |
| Resin 20 | 40% | | | 37.50 | |
| Resin 21 | 40% | | | | 37.50 |
| Lanco ™ Glidd | 15% | 1.00 | 1.00 | 1.00 | 1.00 |
| 4415 | | | | | |
| Curaphen 40-856- | 60% | 6.67 | 6.67 | 6.67 | 6.67 |
| B60 | | | | | |
| Desmodur ® BL | 60% | 1.67 | 1.67 | 1.67 | 1.67 |
| 2078/2 | | | | | |
| Nacure ® XC-296B | 28% | 0.10 | 0.10 | 0.10 | 0.10 |
| Solvent Blend | 0% | 3.07 | 3.07 | 3.07 | 3.07 |
| (Xylene, Butanol, | | | | | |
| MAK 30/30/40) | | | | | |

| | | | | |
|---|---|---|---|---|
| Total | 50.00 | 50.00 | 50.00 | 50.00 |

Calculations:

| | | | | |
|---|---|---|---|---|
| % Total solid binder | 40.00% | 40.00% | 40.00% | 40.00% |
| % Polyesteramide on total binder | 75.00% | 75.00% | 75.00% | 75.00% |
| % IPDI on total binder | 5.00% | 5.00% | 5.00% | 5.00% |
| % Phenolic on total binder | 20.00% | 20.00% | 20.00% | 20.00% |
| % H3PO4 as is on binder | 0.50% | 0.50% | 0.50% | 0.50% |

### Example 11: Coating Properties of Gold Coating Formulation B Based on Resin 8-21 (GFB-8 to GFB-21)

The formulations prepared from Example 11 were applied on tin panels available from Reynolds Metals Company-0.19 mm thickness, 2.2 g/m² tin content, temper and annealing type DR-8CA (described as Reynolds substrate) by casting wet films with wire wound rods—RDS 20 (available from R.D. Specialties, Inc.). This yielded a final dry film weight to achieve approximately 10-11 grams/m². The cast panels were placed in a rack and held vertically in an oven for cure. A Despatch forced air oven was preheated to a setting temperature of 203° C. The coated panels in the rack were then placed into the oven for 18 minutes of bake cycle time in order to allow the coatings to be baked at 200° C. Peak Metal Temperature (PMT) for 10 minutes. In conclusion of baking cycle, the panel rack was removed from oven and allowed to cool to ambient conditions. A Sencon SI9600 coating thickness gauge was used to confirm the dry film weight of the applied coating. Once the coatings were made, coating performance tests including MEK Double Rubs, Wedge Bend, Micro-cracking and Sterilization Resistance Testing were performed on them. For Micro-cracking test, the wet films were casted using wire wound rods—RDS 6 (available from R.D. Specialties, Inc.) which yielded a final dry film weight to achieve approximately 3.0-3.5 grams/m².

For Erichsen cup test, the formulations were also applied to tin panels available from Lakeside Metals Inc. —0.23 mm thickness, 2.2 g/m² tin content, temper and annealing type T61CA (described as Lakeside substrate). The wet films were casted using wire wound rods—RDS 20 (available from R.D. Specialties, Inc.) which yielded a final dry film weight to achieve approximately 10-11 grams/m². All the testing results are listed in Table 19.

TABLE 19
Coating Properties of Gold Formulation B Based on Resin 8-21.

| | | | | | Erichsen | Erichsen |
|---|---|---|---|---|---|---|
| | MEK | Pass % of | Micro- | | cup test | cup test |
| | Double | wedge | cracking | Total | (before | (after |
| Examples | Rubs | bend | rating | Retort % | retort) | retort) |
| GFB-8 | 100+ | 91% | NA | 96% | 3.0 | 0.0 |
| GFB-9 | 100+ | 91% | NA | 87% | 2.5 | 0.0 |
| GFB-10 | 100+ | 95% | NA | 84% | 4.0 | 0.0 |
| GFB-11 | 100+ | 98% | 3.5 | 97% | 3.5 | 1.5 |
| GFB-12 | 100+ | 89% | NA | 88% | 4.0 | 2.0 |
| GFB-13 | 100+ | 93% | NA | 92% | 4.0 | 1.5 |
| GFB-14 | 100+ | 94% | NA | 95% | 4.0 | 1.5 |
| GFB-15 | 64 | 87% | NA | 87% | 2.5 | 0.0 |
| GFB-16 | 100+ | 95% | NA | 92% | 4.0 | 0.0 |
| GFB-17 | 100+ | 89% | NA | 82% | 2.0 | 0.0 |
| GFB-18 | 35 | 98% | 3.0 | 92% | 4.0 | 2.0 |
| GFB-19 | 68 | 94% | 4.0 | 95% | 4.0 | 0.5 |
| GFB-20 | 100+ | 92% | 4.0 | 89% | 4.0 | 0.0 |
| GFB-21 | 100+ | 97% | 3.0 | 93% | 4.0 | 0.0 |

### Example 12: Preparation of Gold Coating Formulation C Based on Resin 11-14 (GFB-11 to GFB-14)

Coating formulation C intended for gold color were prepared by using Resins 11-14. The gold formulations (GFC-11 to GFB-14) prepared from Resin 11 to Resin 14, respectively are listed in Table 20.

Prior to formulating, all polyesteramides were diluted in A150 ND to 40 wt. % solids. The solvent blends were made from the mixture of xylene, butanol and MAK at 30%, 30% and 40% by weight, respectively. An empty glass jar with a lid was labeled and pre-weighted to record the tare weight. For each formulation, Curaphen 40-856-B60, Lanco™ Glidd 4415, Desmodur® BL 2078/2, Nacure® XC-296B and the solvent blend were weighed out respectively and added, in order, to the resin solution while stirring with Dispermat™ high speed disperser. The formulation was then sheared for 10-15 minutes at 1500 RPMs with a Cowles blade on a Dispermat™ high speed disperser. Once it was completed, the glass jar containing the formulation was then rolled overnight with slight agitation at ambient conditions.

A food grade approved Desmodur® BL 2078/2 available from Covestro AG, and Curaphen 40-856-B60 available from Bitrez were chosen as blocked IPDI trimer and m-cresol phenolic-formaldehyde resin crosslinkers, respectively. A food grade approved Nacure® XC-296B available from King Industrials was chosen as H₃PO₄ catalyst. A food grade approved Lanco™ Glidd 4415 from Lubrizol was chosen as wax.

TABLE 20
Gold Coating Formulation C Based on Resins 11-14

| | | GFC-11 | GFC-12 | GFC-13 | GFC-14 |
|---|---|---|---|---|---|
| | Solids/ | Weight | Weight | Weight | Weight |
| Component | Active % | (g) | (g) | (g) | (g) |
| Resin 11 | 40% | 40.00 | | | |
| Resin 12 | 40% | | 40.00 | | |
| Resin 13 | 40% | | | 40.00 | |
| Resin 14 | 40% | | | | 40.00 |
| Curaphen 40-856- | 60% | 1.00 | 1.00 | 1.00 | 1.00 |
| B60 | | | | | |
| Lanco ™M Glidd | 15% | 1.00 | 1.00 | 1.00 | 1.00 |
| 4415 | | | | | |
| Curaphen 40-856- | 60% | 2.33 | 2.33 | 2.33 | 2.33 |
| B60 | | | | | |
| Desmodur ® BL | 60% | 3.33 | 3.33 | 3.33 | 3.33 |
| 2078/2 | | | | | |
| Nacure ® XC-296B | 28% | 0.10 | 0.10 | 0.10 | 0.10 |
| BYK ® - 392 | 52% | 0.25 | 0.25 | 0.25 | 0.25 |
| Solvent Blend | 0% | 1.99 | 1.99 | 1.99 | 1.99 |
| (Xylene, Butanol, | | | | | |
| MAK 30/30/40) | | | | | |

| | | | | |
|---|---|---|---|---|
| Total | 50.00 | 50.00 | 50.00 | 50.00 |

Calculations:

| | | | | |
|---|---|---|---|---|
| % Total solid binder | 40.00% | 40.00% | 40.00% | 40.00% |
| % Polyesteramide on total binder | 80.00% | 80.00% | 80.00% | 80.00% |
| % IPDI on total binder | 10.00% | 10.00% | 10.00% | 10.00% |
| % Phenolic on total binder | 10.00% | 10.00% | 10.00% | 10.00% |
| % H3PO4 as is on binder | 0.50% | 0.50% | 0.50% | 0.50% |

### Example 13: Coating Properties of Gold Coating Formulation C Based on Resin 11-14 (GFB-11 to GFB-14)

The formulations prepared from Example 13 were applied on tin panels available from Reynolds Metals Company-0.19 mm thickness, 2.2 g/m² tin content, temper and annealing type DR-8CA (described as Reynolds substrate) by casting wet films with wire wound rods—RDS 20 (available from R.D. Specialties, Inc.). This yielded a final dry film weight to achieve approximately 10-11 grams/m². The cast panels were placed in a rack and held vertically in an oven for cure. A Despatch forced air oven was preheated to a setting temperature of 203° C. The coated panels in the rack were then placed into the oven for 18 minutes of bake cycle time in order to allow the coatings to be baked at 200° C. Peak Metal Temperature (PMT) for 10 minutes. In conclusion of baking cycle, the panel rack was removed from oven and allowed to cool to ambient conditions. A Sencon SI9600 coating thickness gauge was used to confirm the dry film weight of the applied coating. Once the coatings were made, coating performance tests including MEK Double Rubs, Wedge Bend, Micro-cracking and Sterilization Resistance Testing were performed on them. For Micro-cracking test, the wet films were casted using wire wound rods—RDS 6 (available from R.D. Specialties, Inc.) which yielded a final dry film weight to achieve approximately 3.0-3.5 grams/m².

For Erichsen cup test, the formulations were also applied to tin panels available from Lakeside Metals Inc. —0.23 mm thickness, 2.2 g/m² tin content, temper and annealing type T61CA (described as Lakeside substrate). The wet films were casted using wire wound rods—RDS 20 (available from R.D. Specialties, Inc.) which yielded a final dry film weight to achieve approximately 10-11 grams/m². All the testing results are listed in Table 21.

TABLE 21
Coating Properties of Gold Formulation C Based on Resin 11-14

| | | | | | Erichsen | Erichsen |
|---|---|---|---|---|---|---|
| | MEK | Pass % of | Micro- | | cup test | cup test |
| | Double | wedge | cracking | Total | (before | (after |
| Examples | Rubs | bend | rating | Retort % | retort) | retort) |
| GFC-11 | 56 | 99% | 3.0 | 94 | 4.0 | 0.25 |
| GFC-12 | 50 | 98% | 3.5 | 99% | 4.0 | 1.5 |
| GFC-13 | 83 | 97% | 3.0 | 98% | 4.0 | 1.25 |
| GFC-14 | 100+ | 98% | 3.5 | 98% | 4.0 | 1.0 |

### Example 14: Preparation of Gold Coating Formulation C, D and E Based on Resin 18 (GFC-18, GFD-18 and GFE-18)

Coating formulation C, D and E intended for gold color were prepared by using Resins 18. The gold formulations (GFC-18, GFD-18 and GFE-18) prepared from Resin 18 are listed in Table 22.

Prior to formulating, Resin 18 was diluted in A150 ND to 50% solids. The solvent blends were made from the mixture of xylene, butanol and MAK at 30%, 30% and 40% by weight, respectively. An empty glass jar with a lid was labeled and pre-weighted to record the tare weight. For each formulation, Curaphen 40-856-B60, Phenodur® VPR 1785/50MP, Lanco™ Glidd 4415, Desmodur® BL 2078/2, Nacure® XC-296B and the solvent blend were weighed out respectively and added, in order, to the resin solution while stirring with Dispermat™ high speed disperser. The formulation was then sheared for 10-15 minutes at 1500 RPMs with a Cowles blade on a Dispermat™ high speed disperser. Once it was completed, the glass jar containing the formulation was then rolled overnight with slight agitation at ambient conditions.

A food grade approved Desmodur® BL 2078/2 available from Covestro AG, was chosen as blocked IPDI trimer resin crosslinker. Food grade approved Curaphen 40-856-B60 available from Bitrez and Phenodur® VPR 1785/50MP available from Allnex were chosen as phenolic-formaldehyde resin crosslinkers. A food grade approved Nacure® XC-296B available from King Industrials was chosen as H₃PO₄ catalyst. A food grade approved Lanco™ Glidd 4415 from Lubrizol was chosen as wax.

TABLE 22
Resin 18 in Gold Coating Formulation C, D and E

| | Solids/ | GFC-18 | GFD-18 | GFE-18 |
|---|---|---|---|---|
| Component | Active % | Weight (g) | Weight (g) | Weight (g) |
| Resin 18 | 50% | 72.00 | | |
| Resin 18 | 50% | | 67.50 | 72.00 |
| Curaphen 40-856-B60 | 60% | 2.00 | 2.00 | 2.00 |
| Lanco ™ Glidd 4415 | 15% | 2.00 | 2.00 | 2.00 |
| Curaphen 40-856-B60 | 60% | 5.5 | 5.50 | 5.50 |
| Desmodur ® BL 2078/2 | 60% | 7.5 | 7.50 | 5.63 |
| Phenodur ® VPR | 50% | 0.00 | 4.50 | 2.25 |
| 1785/50MP | | | | |
| Nacure ® XC-296B | 28% | 0.23 | 0.23 | 0.23 |
| BYK ® - 392 | 52% | 0.50 | 0.50 | 0.50 |
| Solvent Blend (Xylene, | 0% | 10.28 | 10.28 | 9.90 |
| Butanol, MAK | | | | |
| 30/30/40) | | | | |

| | | | |
|---|---|---|---|
| Total | 100.00 | 100.00 | 100.00 |

Calculations:

| | | | |
|---|---|---|---|
| % Total solid binder | 45.00% | 45.00% | 45.00% |
| % Polyesteramide on total binder | 80.00% | 75.00% | 80.00% |
| % IPDI on total binder | 10.00% | 10.00% | 7.50% |
| % Phenolic on total binder | 10.00% | 15.00% | 12.50% |
| % H3PO4 as is on binder | 0.50% | 0.50% | 0.50% |

### Example 15: Coating Properties of Gold Coating Formulation C, D and E Based on Resin 18 (GFC-18, GFD-18 and GFE-18)

The formulations prepared from Example 15 were applied on tin panels available from Reynolds Metals Company-0.19 mm thickness, 2.2 g/m² tin content, temper and annealing type DR-8CA (described as Reynolds substrate) by casting wet films with wire wound rods—RDS 20 (available from R.D. Specialties, Inc.). This yielded a final dry film weight to achieve approximately 10-11 grams/m² for a single layer application and 20 grams/m² for a double layer application. GFC-18 was applied as a single and double layer system while GFD-18 and GFE-18 were applied as a double layer system. The cast panels were placed in a rack and held vertically in an oven for cure. A Despatch forced air oven was preheated to a setting temperature of 203° C. The coated panels in the rack were then placed into the oven for 18 minutes of bake cycle time in order to allow the coatings to be baked at 200° C. Peak Metal Temperature (PMT) for 10 minutes. In conclusion of baking cycle, the panel rack was removed from oven and allowed to cool to ambient conditions. A Sencon SI9600 coating thickness gauge was used to confirm the dry film weight of the applied coating. Once the coatings were made, coating performance tests including MEK Double Rubs, Wedge Bend and Sterilization Resistance Testing were performed on them.

For Erichsen cup test, the formulations were also applied to tin panels available from Lakeside Metals Inc. —0.23 mm thickness, 2.2 g/m² tin content, temper and annealing type T61CA (described as Lakeside substrate). The wet films were casted using wire wound rods—RDS 20 (available from R.D. Specialties, Inc.) which yielded a final dry film weight to achieve approximately 10-11 grams/m² for a single layer application and 20 grams/m² for a double layer application. All the testing results are listed in Table 23.

TABLE 23
Coating Properties of Resin 18 in Coating Formulation D and E.

| | | | | Erichsen | Erichsen |
|---|---|---|---|---|---|
| | MEK | Pass % | Total | cup test | cup test |
| | Double | of wedge | Retort | (before | (after |
| Examples | Rubs | bend | % | retort) | retort) |
| GFC-18 - Single | 51 | 97% | 96% | 4.0 | 4.0 |
| Layer | | | | | |
| GFC-18 - Double | 32 | 99% | 97% | 4.0 | 2.0 |
| Layer | | | | | |
| GFD-18 - Double | 100+ | 99% | 98% | 4.0 | 3.5 |
| Layer | | | | | |
| GFE-18 - Double | 100+ | 99% | 98% | 4.0 | 4.0 |
| Layer | | | | | |

### Example 16: Preparation of White Coating Formulation Based on Resin 13 and Resin 18 (WF-13 and WF-18)

Coating formulations intended for white color were prepared by using Resin 13 and Resin 18. The white formulations, WF-13 to WF-18, prepared from Resin 13 and Resin 18, respectively are listed in Table 24.

Prior to formulating, Resin 13 was first diluted in A150 ND to 40 wt. % solids while Resin 18 was diluted in A150 ND to 48.2%. The solvent blending was made from the mixture of xylene, butanol and MAK at 30%, 30% and 40% by weight, respectively. An empty glass jar with a lid was labeled and pre-weighted to record the tare weight. To prepare the pigment paste, half of the polyesteramide solution (32.5 g for Resin 13, 28.7 g for Resin 18) was added to the pre-weighed glass jar. Ti-Pure™ R900 was then gradually added into the polyester resin solution with a shear rate of 800-1000 RPMs with a Cowles blade on a Dispermat™ high speed disperser. Once all the pigment was added, the shear rate was then increased to 3000 RPMs for 15 minutes. The remaining ingredients including remaining Polyesteramide, Lanco™ Glidd 4415, Desmodur® BL 2078/2, BYK®—392, diluted Fastcat® 9102 and the solvent blend were added into the formulation while stirring with a lab mixer until all ingredients are well mixed. Once it was completed, the glass jar containing the formulation was then rolled overnight with slight agitation at ambient conditions.

A food grade approved Desmodur® BL 2078/2 available from Covestro AG, was chosen as blocked IPDI trimer resin crosslinker. A food grade approved Fastcat® 9102 available commercially from PMC Organometallix was chosen as organo-Tin catalyst. A food grade approved Ti-Pure™ R900 available commercially from Chemours was chosen as TiO₂ pigment. BYK®-392 commercially available from BYK were chosen as surface additives. A food grade approved Lanco™ Glidd 4415 from Lubrizol was chosen as wax.

TABLE 24
White Coating Formulation Based on Resin 13 and Resin 18

| | Solids/ | WF-13 | WF-18 |
|---|---|---|---|
| Component | Active wt. % | Weight (g) | Weight (g) |
| Resin 13 | 40% | 65.00 | |
| Resin 18 | 48.2% | | 57.31 |
| Lanco ™ Glidd 4415 | 15% | 2.00 | 2.00 |
| Ti-Pure ™ R 900 TiO2 | 100% | 20.00 | 20.00 |
| Desmodur ® BL 2078/2 | 60% | 10.83 | 11.51 |
| BYK ® - 392 | 52% | 0.54 | 0.54 |
| Fastcat ® 9102, 10% in A100 | 10% | 0.49 | 0.51 |
| Solvent Blend (Xylene, | 0% | 1.14 | 8.13 |
| Butanol, MAK 30/30/40) | | | |

| | | |
|---|---|---|
| Total | 100.00 | 100.00 |
| % Total solid binder | 32.5% | 34.53% |
| % Pigment | 20.00% | 20.00% |
| % Total solids | 52.8% | 54.90% |
| % Polyesteramide on total binder | 80.00% | 80.00% |
| % IPDI on total binder | 20.00% | 20.00% |
| % Tin catalyst on total binder | 0.15% | 0.15% |

### Example 17: Coating Properties of White Coating Formulation Based on Resin 13 and Resin 18 (WF-13 and WF-18)

The formulations prepared from Example 16 were applied on tin panels available from Reynolds Metals Company by casting wet films with wire wound rods—RDS 14 (available from R.D. Specialties, Inc.). This yielded a final dry film weight) to achieve approximately 14-16 grams/m² for pigmented coatings. The cast panels were placed in a rack and held vertically in an oven for cure. A Despatch forced air oven was preheated to a setting temperature of 203° C. The coated panels in the rack were then placed into the oven for 18 minutes of bake cycle time in order to allow the coatings to be baked at 200° C. Peak Metal Temperature (PMT) for 10 minutes. In conclusion of baking cycle, the panel rack was removed from oven and allowed to cool back to ambient conditions. A Sencon SI9600 coating thickness gauge was used to confirm the dry film weight of the applied coating. Once the coatings were made, coating performance tests including MEK Double Rubs, Wedge Bend and Sterilization Resistance Testing were performed on them. The testing results are listed in Table 25.

TABLE 25
Coating Properties of Resin 13 and 18 in White Formulation

| | MEK | Pass % | | Erichsen cup | Erichsen cup |
|---|---|---|---|---|---|
| | Double | of wedge | Total | test (before | test (after |
| Examples | Rubs | bend | Retort % | retort) | retort) |
| GFC-13 | 67 | 92% | 83% | NA | NA |
| GFC-18 | 100+ | 84% | 85% | NA | NA |

### Example 18: Demonstration of Reaction Between Polyesteramide and Phenolic Resins using Model Compound Reactions

Model compound studies were conducted using n-butyl propionamide and 4,6-di-t-butyl-2-hydroxymethyl phenol as analog of amide-containing polyester and phenolic resins, respectively. The structures of the starting materials and expected product are shown in Scheme 1.

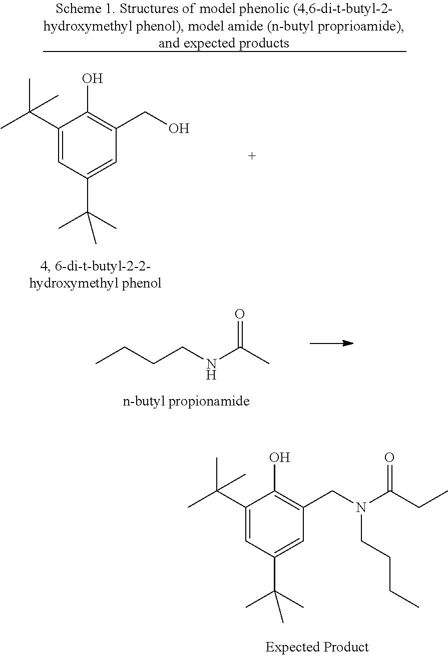

In a typical experiment, 123 mg of n-butyl propionamide and 150 mg of 4,6-di-t-butyl-2-hydroxymethyl phenol were added to a vial. Then, 0.62 gram of catalyst solution in acetone (0.12 wt % solid catalyst) was added into the mixture to dissolve the reactants. Upon dissolution, the mixture was placed in an oven maintained at 180° C. for 18 minutes. The catalysts used were Nacure XC296B (phosphoric acid), Nacure 5076/Dodecyl Benzene Sulfonic Acid (DDBSA), Fascat 9102, K-Kat 672, Diazobicycloundecene (DBU), and Tetramethyl ammonium hydroxide (TMAH). The resulting products were analyzed with gas chromatography coupled with mass spectrometer for identification of reaction product shown in Scheme 1. Table 26 lists the model compound reactions under various catalyst conditions.

TABLE 26
List of model compound reactions under various catalyst conditions

| | | Amt. of 4,6- | | Amt. of | |
|---|---|---|---|---|---|
| | Amt. of | di-t-butyl-2- | | Catalyst | Product |
| | n-butyl | hydroxy- | | Solution | Detected |
| | pro- | methyl | | (0.12 wt % | via |
| Exam- | pionamide | phenol | Catalyst | in Acetone) | GC/MS |
| ple 18 | (mg) | (mg) | Type | (g) | (Yes/No?) |
| MA-1 | 123 | 150 | None | 0.62 | Yes |
| MA-2 | 123 | 150 | Nacure | 0.62 | Yes |
| | | | XC296B | | |
| MA-3 | 123 | 150 | Nacure | 0.62 | Yes |
| | | | 5076 | | |
| MA-4 | 123 | 150 | Fascat | 0.62 | Yes |
| | | | 9102 | | |
| MA-5 | 123 | 150 | K-Kat 672 | 0.62 | Yes |
| MA-6 | 123 | 150 | DBU | 0.62 | Yes |
| MA-7 | 123 | 150 | TMAH | 0.62 | Yes |

### Example 19: Demonstration of Reaction Between Polyesteramide Resin and ISOCYANATE Crosslinker using Model Compound Reaction

The reaction between amide moiety in polyesteramide resin with isocyanate crosslinker is demonstrated via reaction rate kinetics investigation using Fourier Transform Infra-Red spectroscopy employing model molecule n-butyl propionamide and unblocked isocyanate, IPDI trimer, Desmodur Z 4470. The disappearance of isocyanate peak (at ˜2250 cm⁻¹) was monitored over a period of 15 minutes. The area under the curve was integrated and fitted into a second-order kinetic model to obtain a straight line with slope. The slope of (1/Isocyanate Peak Area) vs. time is indicative of reaction rate constant. If reaction rate constant of isocyanate and n-butyl propionamide (k_{amide-iso}) is higher than that between isocyanate (kᵢₛₒ₋ᵢₛₒ), then amide group reaction with isocyanate is demonstrated.

In a typical experiment, 0.3 grams of Desmodur Z 4470 (70% in n-butyl acetate, isocyanate eq. wt. 360 g/mole) was combined with 0.5 gram of n-butyl propionamide solution in acetone. The composition of this solution is 43 wt % n-butyl propionamide and 0.2552 wt % catalyst. The mixture was stirred for 2 minutes and then applied onto IR crystal whose temperature is maintained at 180° C. The disappearance of isocyanate peak was monitored over 15 minutes.

As control experiments, isocyanate is reacted with itself under various catalyst conditions to compare the reaction rate constants in the absence of n-butyl propionamide. In a typical experiment, 0.3 grams of Desmodur Z 4470 is combined with catalyst solution in acetone (0.126 wt %). The mixture was stirred for 2 minutes and then applied onto IR crystal whose temperature is maintained at 180° C. The disappearance of isocyanate peak was monitored over 15 minutes. Table 27 lists the rate constants of amide-isocyanate and isocyanate-isocyanate reactions under various catalytic conditions. Amide group reaction with isocyanate is shown by the higher value of k_{amide-iso} over kᵢₛₒ₋ᵢₛₒ.

TABLE 27
Comparison of reaction rate constants of amide-isocyanate and
isocyanate self-reaction under various catalytic conditions

| Catalyst | k_{amide-iso} | kᵢₛₒ₋ᵢₛₒ | k_{amide-iso} > kᵢₛₒ₋ᵢₛₒ |
|---|---|---|---|
| System | (×10⁻⁴) | (×10⁻⁴) | (Yes/No?) |
| None | 0.253 | 0.1 | Yes |
| Nacure XC296 | 1.311 | 0.610 | Yes |
| Nacure 5076 | 2.30 | 0.903 | Yes |
| Fascat 9102 | 5.66 | 3.01 | Yes |
| K-Kat XK-672 | 5.5 | 5.91 | Yes |

### Example 20: Synthesis of Branched Polyesteramides Having Various Ratios of HDA (Resins 22-25)

Using the same method as above, resins 22-25 were also synthesized by using HDA ratios of 2 or 5 mole %. Table 28 lists the compositions of Resins 22-25, and Table 29 lists their resin properties.

TABLE 28
Synthesized Branched Polyesteramides Having Various Ratios of HDA

| | Resin Composition as Charged | | | | | | | |
|---|---|---|---|---|---|---|---|---|
| | Mole Ratio Based on Total Alcohols (%) | | | | | Mole Ratio Based | | |
| | | 1,4- | | | | on Total Acids (%) | | |
| | TMCD | CHDM | MPdiol | TMP | HDA | TPA | IPA | AD |
| Resin 22 | 39 | 37 | 20 | 2 | 2 | 30 | 65 | 5 |
| Resin 23 | 38 | 36 | 19 | 2 | 5 | 30 | 65 | 5 |
| Resin 24 | 44 | 42 | 10 | 2 | 2 | 30 | 70 | 0 |
| Resin 25 | 43 | 41 | 9 | 2 | 5 | 30 | 70 | 0 |

TABLE 29
Resin Properties of Polyesteramides

| | | | | | | Acid | OH | Solubility |
|---|---|---|---|---|---|---|---|---|
| | Tg, ° | | | | | Number | Number | (50% |
| | C. | Mn | Mw | PDI | IV | Analyzed | Analyzed | solids) |
| Resin 22 | 81 | 11726 | 37561 | 3.20 | 0.351 | 1.7 | 19.3 | Soluble in |
| | | | | | | | | A150ND |
| Resin 23 | 83 | 9839 | 33259 | 3.38 | 0.355 | 3.4 | 25.3 | Soluble in |
| | | | | | | | | A150ND |
| Resin 24 | 89 | 9519 | 26459 | 2.78 | 0.264 | 1.8 | 27.3 | Soluble in |
| | | | | | | | | A150ND |
| Resin 25 | 91 | 9893 | 30088 | 3.04 | 0.311 | 2.8 | 22.1 | Soluble in |
| | | | | | | | | A150ND |

### Example 21: Synthesis of Unsaturated Polyesteramides Having Various Ratios of HDA (Resins 26-29)

This example illustrates the synthesis of polyesteramide containing 5 mole % maleic anhydride (MA) and 1˜10 mole % of 1,6-hexamethylene diamine (HDA).

The polyesteramides were produced using a resin kettle reactor controlled with automated control software. The resins were produced on a 3.5 mole scale using a 2 L kettle with overhead stirring and a partial condenser topped with total condenser and Dean Stark trap. Approximately 10 wt % (based on reaction yield) azeotroping solvent of high boiling point Aromatic 150ND (A150ND, available from ExxonMobil) was used to both encourage egress of the water condensate out of the reaction mixture and keep the reaction mixture from becoming excessively viscous using the standard paddle stirrer. Isophthalic acid (IPA), terephthalic acid (TPA), 1,4-cyclohexane dimethanol (CHDM), 2,2,4,4-tetramethyl-1,3-cyclobutanediol (TMCD), 2-methyl-1,3-propanediol (MPdiol), diamine monomer, and Aromatic 150 were added to the reactor. Fascat 4100 (monobutyltin oxide, available from PMC Organometallix Inc., 400 ppm) or the stock solution of titanium isopropoxide (TTIP, available from MilliporeSigma Inc., 160 ppm) in A150ND was added via the sampling port after the reactor had been assembled and blanketed with nitrogen for the reaction. Additional A150ND solvent was added to the Dean Stark trap to maintain the ˜10 wt % solvent level in the reaction kettle. The reaction mixture was heated without stirring from room temperature to 150° C. using a set output controlled through the automation system. Once the reaction mixture was sufficiently fluid, the stirring was started to encourage even heating of the mixture. At 150° C., the control of heating was switched to automated control and the temperature was ramped to 230° C. over the course of 4 hours. The reaction was held at 230° C. for 1 hour and then heated to 240° C. over the course of 1 hour. The reaction was then held at 240° C. and sampled every 0.5-1 hour upon clearing until the desired acid value for Stage 1 (less than 3) was reached. An overnight hold temperature of 150° C. was utilized, and any additional A150ND necessary to reach the desired ˜10 wt % was added at 150° C. prior to reheating to the reaction temperature. Upon reaching the Stage 1 target acid value, the reaction mixture was cooled to 190° C., and 4-methoxyphenol (MeHQ, 1% by weight based on MA) was added and allowed to stir for 15 m. Next, maleic anhydride (MA) was added to the reaction mixture and heated to 220-230° C. at 1.5° C./m. The acid value was monitored every 30-60 m until the final desired acid value was reached. The reaction mixture was then further diluted with A150ND or other solvents to target a weight percent solid of 50%. This solution was filtered through a ˜250 μm paint filter prior to use in the formulation and application testing. It should be noted that the glycol excesses were determined empirically for the lab reactor and may be different depending on the partial condenser and reactor design used.

Using the same method as above, resins 26-29 were also synthesized by using HDA ratios of 1˜10 mole %. Table 30 lists the compositions of Resins 26-29, and Table 31 lists their resin properties.

TABLE 30
Synthesized Unsaturated Polyesteramides Having Various Ratios of HDA

| | Resin Composition as Charged | | | | | | |
|---|---|---|---|---|---|---|---|
| | Mole Ratio Based on Total Alcohols (%) | | | | Mole Ratio Based | | |
| | | 1,4- | | | on Total Acids (%) | | |
| | TMCD | CHDM | MPdiol | HDA | TPA | IPA | MA |
| Resin 26 | 45 | 34 | 20 | 1 | 35 | 60 | 5 |
| Resin 27 | 45 | 33 | 20 | 2 | 35 | 60 | 5 |
| Resin 28 | 45 | 30 | 20 | 5 | 35 | 60 | 5 |
| Resin 29 | 40.5 | 31.5 | 18 | 10 | 35 | 60 | 5 |

TABLE 31
Resin Properties of Polyesteramides

| | | | | | | Acid | OH | Solubility |
|---|---|---|---|---|---|---|---|---|
| | Tg, ° | | | | | Number | Number | (50% |
| | C. | Mn | Mw | PDI | IV | Analyzed | Analyzed | solids) |
| Resin 26 | 91 | 13361 | 35320 | 2.64 | 0.348 | 1 | 11 | Soluble in |
| | | | | | | | | A150ND |
| Resin 27 | 91 | 10053 | 26678 | 2.65 | 0.306 | 3 | 16 | Soluble in |
| | | | | | | | | A150ND |
| Resin 28 | 93 | 12076 | 40758 | 3.38 | 0.393 | 2 | 16 | Soluble in |
| | | | | | | | | A150ND |
| Resin 29 | 97 | 11554 | 62850 | 5.44 | 0.485 | 7 | 10 | Soluble in |
| | | | | | | | | MAK |

### Example 22: Preparation of Clear Coating Formulation Based on Resin 22-25 (CF-22, to CF-25)

Coating formulation intended for clear easy open beverage ends was prepared by using Resins 22-25. The clear formulations (CF-22 to CF-25) prepared from Resins 22-25, respectively are listed in Table 32.

Prior to formulating, all polyesteramides were diluted in A150 ND to 50 wt. % solids. The solvent blend was made from the mixture of xylene, butanol and MAK at 30%, 30% and 40% by weight, respectively. An empty glass jar with a lid was labeled and pre-weighted to record the tare weight. For each formulation, Maprenal® BF 987, Cymel® 325, diluted Nacure® 5076, BYK®-392, Lanco™ Glidd 4415 and the solvent blend were weighed out respectively and added to the resin solution in order. The formulation was then stirred for 10-15 minutes at 1500 RPMs with a Cowles blade on a Dispermat™ high speed disperser. Once it was completed, the glass jar containing the formulation was then rolled overnight with slight agitation at ambient conditions.

A food grade approved Maprenal® BF 987 available from Prefere Melamines, and Cymel® 325 available from allnex were chosen as methylated benzoguanamine formaldehyde resin and methylated melamine resin crosslinkers, respectively. A food grade approved Nacure® 5076 available from King Industrials was chosen as acid catalyst based on Dodecylbenzenesulfonic acid (DDBSA). BYK®—392 commercially available from BYK was chosen as surface additive. A food grade approved Lanco™ Glidd 4415 from Lubrizol was chosen as wax.

TABLE 32
Clear Formulation (CF) Based on Resin 22-25

| | | CF-22 | CF-23 | CF-24 | CF-25 |
|---|---|---|---|---|---|
| | Solids/ | Weight | Weight | Weight | Weight |
| Component | Active % | (g) | (g) | (g) | (g) |
| Resin 22 | 50% | 30.00 | | | |
| Resin 23 | 50% | | 30.00 | | |
| Resin 24 | 50% | | | 30.00 | |
| Resin 25 | 50% | | | | 30.00 |
| Maprenal ® BF 987 | 74% | 4.05 | 4.05 | 6.76 | 6.76 |
| Lanco ™ Glidd | 15% | 1.00 | 1.00 | 1.00 | 1.00 |
| 4415 | | | | | |
| Cymel ® 325 | 80% | 2.50 | 2.50 | | |
| Nacure ® 5076 | 10% | 0.40 | 0.40 | 0.40 | 0.40 |
| 10% in Butanol | | | | | |
| BYK ® - 392 | 52% | 0.10 | 0.10 | 0.10 | 0.10 |
| Solvent Blend | 0% | 11.95 | 11.95 | 10.75 | 10.75 |
| (Xylene, Butanol, | | | | | |
| MAK 30/30/40) | | | | | |

| | | | | |
|---|---|---|---|---|
| Total | 50.00 | 50.00 | 50.00 | 50.00 |

Calculations:

| | | | | |
|---|---|---|---|---|
| % Total solid binder | 40.00% | 40.00% | 40.00% | 40.00% |
| % Polyesteramide on total binder | 75.00% | 75.00% | 75.00% | 75.00% |
| % Benzoguanamine on total binder | 15.00% | 15.00% | 25.00% | 25.00% |
| % Melamine on total binder | 10.00% | 10.00% | 0.00% | 0.00% |
| % DDBSA as is on binder | 0.20% | 0.20% | 0.20% | 0.20% |

### Example 23: Coating Properties of Clear Coating Formulation Based on Resin 22-25 (CF-22 to CF-25)

The formulations prepared from Example 23 were applied on zirconium treated aluminum substrate—0.208 mm thickness, A42S alloy and H29 temper by casting wet films with wire wound rods—RDS 20 (available from R.D. Specialties, Inc.). This yielded a final dry film weight to achieve approximately 10-11 grams/m² for clear easy open beverage ends. A Despatch forced air oven was preheated to a setting temperature of 350° C. The coated panels were then placed into the oven for 32 seconds of bake cycle time in order to allow the coatings to be baked at 240° C. Peak Metal Temperature (PMT) for 10 seconds. In conclusion of baking cycle, the panel was removed from the oven and allowed to cool back to ambient conditions. A Sencon SI9600 coating thickness gauge was used to confirm the dry film weight of the applied coating. Once the coatings were made, coating performance tests including MEK Double Rubs and Reverse Impact were performed on them. The testing results are listed in Table 33.

TABLE 33
Coating Properties of Resin 22-25 in Clear Formulation.

| Examples | MEK Double Rubs | Reverse Impact (Average) |
|---|---|---|
| CF-22 | 83 | 2.50 |
| CF-23 | 25 | 2.50 |
| CF-24 | 28 | 2.50 |
| CF-25 | 17 | 2.00 |

### Example 24: Preparation of Clear Coating Formulation Based on Resin 26-29 (CF-26, to CF-29)

Coating formulation intended for clear easy open beverage ends was prepared by using Resins 26-29. The clear formulations (CF-26 to CF-29) prepared from Resins 26-29, respectively are listed in Table 34.

Prior to formulating, all polyesteramides were diluted in A150 ND to 50 wt. % solids. The solvent blend was made from the mixture of xylene, butanol and MAK at 30%, 30% and 40% by weight, respectively. An empty glass jar with a lid was labeled and pre-weighted to record the tare weight. For each formulation, Maprenal® BF 987, Cymel® 325, diluted Nacure® 5076, BYK®-392, Lanco™ Glidd 4415 and the solvent blend were weighed out respectively and added to the resin solution in order. The formulation was then stirred for 10-15 minutes at 1500 RPMs with a Cowles blade on a Dispermat™ high speed disperser. Once it was completed, the glass jar containing the formulation was then rolled overnight with slight agitation at ambient conditions.

A food grade approved Maprenal® BF 987 available from Prefere Melamines, and Cymel® 325 available from allnex were chosen as methylated benzoguanamine formaldehyde resin and methylated melamine resin crosslinkers, respectively. A food grade approved Nacure® 5076 available from King Industrials was chosen as acid catalyst based on Dodecylbenzenesulfonic acid (DDBSA). BYK®—392 commercially available from BYK was chosen as surface additive. A food grade approved Lanco™ Glidd 4415 from Lubrizol was chosen as wax.

TABLE 34
Clear Formulation (CF) Based on Resin 26-29

| | | CF-26 | CF-27 | CF-28 | CF-29 |
|---|---|---|---|---|---|
| | Solids/ | Weight | Weight | Weight | Weight |
| Component | Active % | (g) | (g) | (g) | (g) |
| Resin 26 | 50% | 30.00 | | | Resin |
| | | | | | gelled |
| Resin 27 | 50% | | 30.00 | | |
| Resin 28 | 50% | | | 33.75 | |
| Resin 29 | 50% | | | | |
| Maprenal ® BF 987 | 74% | 4.05 | 4.05 | 4.56 | |
| Lanco ™ Glidd | 15% | 1.00 | 1.00 | 1.00 | |
| 4415 | | | | | |
| Cymel ® 325 | 80% | 2.50 | 2.50 | 2.82 | |
| Nacure ® 5076 | 10% | 0.40 | 0.40 | 0.45 | |
| 10% in Butanol | | | | | |
| BYK ® - 392 | 52% | 0.10 | 0.10 | 0.10 | |
| Solvent Blend | 0% | 11.95 | 11.95 | 7.33 | |
| (Xylene, Butanol, | | | | | |
| MAK 30/30/40) | | | | | |

| | | | |
|---|---|---|---|
| Total | 50.00 | 50.00 | 50.00 |

Calculations:

| | | | |
|---|---|---|---|
| % Total solid binder | 45.00% | 40.00% | 45.00% |
| % Polyesteramide on total binder | 75.00% | 75.00% | 75.00% |
| % Benzoguanamine on total binder | 15.00% | 15.00% | 15.00% |
| % Melamine on total binder | 10.00% | 10.00% | 10.00% |
| % DDBSA as is on binder | 0.20% | 0.20% | 0.20% |

### Example 25: Coating Properties of Clear Coating Formulation Based on Resin 26-29 (CF-26 to CF-29)

The formulations prepared from Example 25 were applied on zirconium treated aluminum substrate—0.208 mm thickness, A42S alloy and H29 temper by casting wet films with wire wound rods—RDS 20 (available from R.D. Specialties, Inc.). This yielded a final dry film weight to achieve approximately 10-11 grams/m² for clear easy open beverage ends. A Despatch forced air oven was preheated to a setting temperature of 350° C. The coated panels were then placed into the oven for 32 seconds of bake cycle time in order to allow the coatings to be baked at 240° C. Peak Metal Temperature (PMT) for 10 seconds. In conclusion of baking cycle, the panel was removed from the oven and allowed to cool back to ambient conditions. A Sencon SI9600 coating thickness gauge was used to confirm the dry film weight of the applied coating. Once the coatings were made, coating performance tests including MEK Double Rubs, Reverse Impact and Sterilization Resistance Testing were performed on them. The testing results are listed in Table 35.

TABLE 35
Coating Properties of Resin 26-29 in Clear Formulation.

| | | Reverse Impact | Total Retort |
|---|---|---|---|
| Examples | MEK Double Rubs | (Average) | % |
| CF-26 | 80 | 3.00 | 98% |
| CF-27 | 100+ | 1.83 | 95% |
| CF-28 | 100+ | 5.00 | 98% |
| CF-29 | Resin gelled | | |

The invention has been described in detail with reference to the embodiments disclosed herein, but it will be understood that variations and modifications can be effected within the spirit and scope of the invention.

1. A coating composition for metal packaging applications, comprising:
a. a polyesteramide, which is the reaction product of the monomers comprising:
i. 2,2,4,4-tetramethyl-1,3-cyclobutanediol (TMCD) in an amount of 25-80 mole %, based on the total moles of i-iv,
ii. a diol other than TMCD in an amount of 15-73 mole %, based on the total moles of i-iv,
iii. an aliphatic diamine in an amount of 0.2-20 mole %, based on the total moles of i-iv,
iv. a polyol in an amount of 0-20 mole %, based on the total moles of i-iv,
v. an aromatic diacid in an amount of 60-100 mole %, based on the total moles of v-vi, and
vi. an aliphatic diacid in an amount of 0-40 mole %, based on the total moles of v-vi, and
b. one or more crosslinkers selected from the group consisting of resole phenolic resin, isocyanate, and amino resin crosslinkers,
wherein said polyesteramide has a glass transition temperature (Tg) of 60-100° C., acid number of 0-10 mg KOH/g, hydroxyl number of 5-60 mg KOH/g, number average molecular weight of 3000-25000 g/mole, and weight average molecular weight of 10000-150000 g/mole.

2. The coating composition of claim 1, wherein the coating exhibits one or more of the following properties:
a solvent resistance of greater than 50 MEK double rubs as measured by ASTM D7835; and
a wedge bend resistance (% pass) of 70-100 as measured by ASTM D3281.

3. The coating composition of claim 1, wherein said diol other than TMCD (ii) is one or more selected from the group consisting of 1,4-cyclohexanedimethanol (1,4-CHDM), 1,3-cyclohexanedimethanol (1,3-CHDM), 2-methyl-1,3-propanediol (MPdiol), neopentyl glycol (NPG), and isosorbide.

4. The coating composition of claim 1, wherein aliphatic diamine (iii) is one or more selected from the group comprising:
1,6-hexamethylenediamine (HDA), 2-methyl-1,5-pentanediamine (MPDA), 4,4′-methylenebis(2-methylcyclohexylamine) (MACM), 4,4′-methylenebis(cyclohexylamine) (PACM), 1,3-cyclohexanebis(methylamine), 1,4-cyclohexanebis(methylamine), 4,4′-methylenebis(3-methylcyclohexan-1-amine), 4-((4-aminocyclohexyl)methyl)-2-methylcyclohexan-1-amine, 4,4′-methylenebis(2,6-dimethylcyclohexan-1-amine), 2,4,5-trimethyl-1,6-hexanediamine, 5-amino-1,3,3-trimethylcyclohexanemethylamine, 1,3-pentanediamine, 1,3-Propanediamine 1,4-butanediamine, 1,5-pentanediamine, 1,7-heptanediamine, 1,8-octanediamine, 1,9-nonanediamine, 1,10-decanediamine, 1,11-undecanediamine, 1,12-dodecanediamine, 4,7,10-trioxa-1,13-tridecanediamine, 2,2′-(ethylenedioxy)diethylamine, and 2-(2-aminoethoxy)ethylamine.

5. The coating composition of claim 1, wherein said polyol (iv) is trimethylolpropane.

6. The coating composition of claim 1, wherein said aromatic diacid (v) is selected from the group consisting of isophthalic acid (IPA), esters of isophthalic acid, terephthalic acid (TPA), esters of terephthalic acid, and mixtures thereof.

7. The coating composition of claim 1, wherein said aliphatic diacid (vi) is one or more selected from the group consisting of succinic acid, adipic acid, sebacic acid, 1,4-cyclohexane dicarboxylic acid, and 1,3-cyclohexane dicarboxylic acid.

8. The coating composition of claim 1, wherein the polyesteramide (a) is the reaction product of an additional monomer comprising an α,β-unsaturated diacid or anhydride selected from the group consisting of maleic anhydride, maleic acid, fumaric acid, itaconic anhydride, and itaconic acid.

9. The coating composition of claim 1, wherein said polyesteramide (a) is in an amount of 50-85 weight % and said crosslinker (b) in an amount of 15-50 weight %, based on the total weight of (a) and (b).

10. The coating composition of claim 1, wherein said resole phenolic resin comprises residues of m-substituted phenol.

11. The coating composition of claim 1, wherein said isocyanate is isophorone diisocyanate.

12. The coating composition of claim 1, wherein said amino crosslinker is a benzoguanamine-formaldehyde type crosslinker.

13. The coating composition of claim 1, wherein the coating composition further comprises one or more organic solvents selected from the group consisting of xylene, methyl amyl ketone, 2-butoxyethanol, ethyl-3-ethoxypropionate, toluene, butanol, cyclopentanone, cyclohexanone, ethyl acetate, butyl acetate, Aromatic 100, and Aromatic 150.

14. The coating composition of claim 1, wherein:
a. the polyesteramide is a linear polyesteramide in an amount of 65-85 wt. %, based on the total weight of (a) and (b) i. which is the reaction product of the monomers comprising:
TMCD is in an amount of 35-45 mole %, based on the total moles of i-iv;
ii. the diol other than TMCD is a mixture of 1,4-cyclohexanedimethanol and 2-methyl-1,3-propanediol, wherein the 1,4-cyclohexanedimethanol is in an amount of 20-45 mole %, based on the total moles of i-iv, and 2-methyl-1,3-propanediol is in an amount of 10-30 mole %, based on the total moles of i-iv;
iii. the aliphatic diamine is in an amount of 0.2-10 mole %, based on the total moles of i-iv;
iv. the polyol is in an amount of 0-20 mole %, based on the total moles of i-iv;
v. the aromatic diacid is a mixture of isophthalic acid and terephthalic acid, wherein the isophthalic acid is in an amount of 60-80 mole %, based on the total moles of v-vi, and the terephthalic acid is in an amount of 20-40 mole %, based on the total moles of v-vi; and
vi. the aliphatic diacid is in an amount of 0-10 mole %, based on the total moles of v-vi; and
b. the one or more crosslinker is a mixture of resole phenolic resin and an isophorone diisocyanate (IPDI), wherein the resole phenolic resin is in an amount of 8-30 weight % based on the total weight of (a) and (b), and the IPDI is in an amount of 3-15 weight % based on the total weight of (a) and (b); and
wherein the linear polyesteramide has a glass transition temperature (Tg) of 70 to 90° C., acid number of 0 to 10 mgKOH/g, hydroxyl number of 5 to 15 mgKOH/g, number average molecular weight of 8,000 to 20,000 mgKOH/g, and weight average molecular weight of 20,000 to 100,000.

15. The coating composition of claim 1, wherein:
a. the polyesteramide is a linear polyesteramide in an amount of 70-90 weight %, based on the total weight of (a) and (b), which is the reaction product of the monomers comprising:
i. TMCD is in an amount of 35-45 mole %, based on the total moles of i-iv;
ii. the diol other than TMCD is a mixture of 1,4-cyclohexanedimethanol and 2-methyl-1,3-propanediol, wherein the 1,4-cyclohexanedimethanol is in an amount of 20-45 mole %, based on the total moles of i-iv, and 2-methyl-1,3-propanediol is in an amount of 10-30 mole %, based on the total moles of i-iv;
iii. the aliphatic diamine is in an amount of 0.2-10 mole %, based on the total moles of i-iv;
iv. the polyol is in an amount of 0-20 mole %, based on the total moles of i-iv;
v. the aromatic diacid is a mixture of isophthalic acid and terephthalic acid, wherein the isophthalic acid is in an amount of 60-80 mole %, based on the total moles of v-vi, and terephthalic acid is in an amount of 20-40 mole %, based on the total moles of v-vi; and
vi. the aliphatic diacid is in an amount of 0-10 mole %, based on the total moles of v-vi; and
b. the one or more crosslinker is an isophorone diisocyanate (IPDI) in an amount of 10-30 weight % based on the total weight of (a) and (b); and
wherein the linear polyesteramide has a glass transition temperature (Tg) of 70 to 90° C., acid number of 0 to 10 mgKOH/g, hydroxyl number of 5 to 15 mgKOH/g, number average molecular weight of 8,000 to 20,000 mgKOH/g, and weight average molecular weight of 20,000 to 100,000.

16. A coating composition for metal packaging application, which comprises:
a. a branched polyesteramide in an amount of 65-85 weight %, based on the total weight of (a), (b), and (c) which is the reaction product of the monomers comprising:
i. 2,2,4,4-tetramethyl-1,3-cyclobutanediol (TMCD) in an amount of 35-45 mole %, based on the total moles of i-v,
ii. 1,4-cyclohexanedimethanol in an amount of 25-45 mole %, based on the total moles of i-v,
iii. 2-methyl-1,3-propanediol in an amount of 5-30 mole %, based on the total moles of i-v,
iv. an aliphatic diamine in an amount of 0.2-10 mole %, based on the total moles of i-v,
v. a polyol in an amount of 1-5 mole %, based on the total moles of i-v,
vi. isophthalic acid in an amount of 60-80 mole %, based on the total moles of vi-viii,
vii. terephthalic acid in an amount of 20-40 mole %, based on the total moles of vi-viii, and
viii. an aliphatic diacid in an amount of 0-10 mole %, based on the total moles of vi-viii,
b. a benzoguanamine/formaldehyde resin in an amount of 10-20 weight % based on the total weight of (a), (b), and (c), and
c. a melamine/formaldehyde resin in in an amount of 5-15 weight % based on the total weight of (a), (b), and (c),
wherein the branched polyesteramide has a glass transition temperature (Tg) of 70 to 100° C., acid number of 0 to 10 mgKOH/g, hydroxyl number of 10 to 30 mgKOH/g, number average molecular weight of 8,000 to 20,000 mgKOH/g, and weight average molecular weight of 20,000 to 100,000.

17. A coating composition for metal packaging application, which comprises:
a. an unsaturated polyesteramide in an amount of 65-85 weight %, based on the total weight of (a) and (b), which is the reaction product of the monomers comprising:
i. 2,2,4,4-tetramethyl-1,3-cyclobutanediol (TMCD) in an amount of 35-50 mole %, based on the total moles of i-iv,
ii. 1,4-cyclohexanedimethanol in an amount of 20-40 mole %, based on the total moles of i-iv,
iii. 2-methyl-1,3-propanediol in an amount of 10-30 mole %, based on the total moles of i-iv,
iv. an aliphatic diamine in an amount of 0.2-15 mole %, based on the total moles of i-iv,
v, isophthalic acid in an amount of 50-70 mole %, based on the total moles of v-viii,
vi. terephthalic acid in an amount of 29-40 mole %, based on the total moles of v-viii,
vii. an α,β-unsaturated dicarboxylic acid or anhydride in an amount of 1 to 15 mole %, based on the total moles of v-viii, and
viii. an aliphatic diacid other than (vii) in an amount of 0-10 mole %, based on the total moles of v-viii,
b. a benzoguanamine/formaldehyde resin in an amount of 10-20 weight % based on the total weight of (a), (b), and (c), and
c. a melamine/formaldehyde resin in in an amount of 5-15 weight % based on the total weight of (a), (b), and (c),
wherein the unsaturated polyesteramide has a glass transition temperature (Tg) of 70 to 100° C., acid number of 0 to 10 mgKOH/g, hydroxyl number of 5 to 20 mgKOH/g, number average molecular weight of 8,000 to 20,000 mgKOH/g, and weight average molecular weight of 20,000 to 100,000.

18. An article, of which at least a portion is coated with the coating composition of claim 1.

19. An article, of which at least a portion is coated with the coating composition of claim 17.
